(19) United States
(12) Patent Application Publication
(10) Pub. No.: US 2008/0034362 A1
(43) Pub. Date: Feb. 7, 2008

(54) Program Acquisition and Execution Apparatus, and Program Acquisition and Execution Method

(75) Inventors: Satoru Hayama, Hyogo (JP); Hisaki Furuyama, Osaka (JP)

Correspondence Address: STEPTOE & JOHNSON LLP, 1330 CONNECTICUT AVE., NW, WASHINGTON, DC, 20036, US

(73) Assignee: MATSUSHITA ELECTRIC INDUSTRIAL CO., LTD., OSAKA (JP)

(21) Appl. No.: 11/792,779

(22) PCT Filed: Jun. 30, 2005
(86) PCT No.: PCT/JP05/12083

§ 371 Date: Jul. 2, 2007

(30) Foreign Application Priority Data
Dec. 10, 2004 (JP) 2004-358825

(51) Int. Cl. G06F 9/445

(52) U.S. Cl. 717/174

(57) ABSTRACT

When plural programs are acquired and executed, if there is a mismatch in communication modes of the programs, the programs cannot communicate with each other.

A program acquisition unit (101) acquires plural programs from a program storage apparatus (150), and a program execution unit (102) executes the acquired programs. When a communication mode mismatch detection unit (304) detects a mismatch in communication modes at performing mutual communication between these plural programs, a communication mode conversion unit (203) converts the communication modes, or the program acquisition unit (102) reacquires the programs, thereby enabling the plural programs to communicate with each other.

### TECHNICAL FIELD

The present invention relates to a program acquisition and execution apparatus, a program acquisition and execution method, a program acquisition and execution program storage medium, and a program acquisition and execution program, and more particularly, to those for obtaining a program by downloading or uploading from a program storage apparatus through a communication medium such as a network or a radio apparatus, and executing the program.

### BACKGROUND ART

There has been a conventional program acquisition and execution apparatus which determines an API specification such that a new version API (Application Programming Interface) is defined so that an old version API is included in the new version API, in order to realize so-called “upper compatibility” by which an old version program can be executed on a new version apparatus even when a new version API is produced for a program that is acquired and executed by the program acquisition and execution apparatus (for example, refer to Non-Patent Document 1: Section 2.8 “Versioning” of “The HAVi Specification Version 1.1”, [online], May 1, 2001, HAVi Inc., [Searched on Sep. 27, 2004], Internet <http://www.havi.org/memberarea/docs/051501Documents/release-May15-HAVi1.1(clean).pdf>).

More specifically, the new version API is defined by adding a new API group to the old version API without changing the specification of the old API at all, in order to secure upper compatibility with respect to the old API.

The API corresponds to a convention of functions such as a library that is prepared in an operating system (OS) or a programming language processing system (e.g., a compiler), which can be utilized from an application program, and the API is often provided as a convention that defines commands and functions having features for file control, window control, image processing, text control and the like or on-program procedures for utilizing the commands and functions.

The API enables a computer software to perform mutual communication with another software in a broad sense. Further, the API is a method for abstracting the relationship between a low-level hardware-like software and a high-level human-like software.

One of the purposes of the API is to provide a feature (function) that can be commonly used for such as window operation and icon drawing. Such function saves programmers the trouble of coding a file control function, a window control function, or the like for each time.

FIG. 18(a) is a diagram illustrating a conventional program acquisition and execution apparatus described in the non-patent document 1.

In FIG. 18(a), the program acquisition and execution apparatus 100 is provided with a program acquisition unit 101 and a program execution unit 102.

Further, a program storage apparatus 150 holds a program to be acquired and executed by the program acquisition and execution apparatus 100.

The program acquisition unit 101 acquires one or plural programs from one or plural program storage apparatuses 150 through a communication medium 200 such as a communication path.

The program execution unit 102 executes the one or plural programs acquired by the program acquisition unit 101.

The program acquired by the program acquisition unit 101 is produced on the basis of a predetermined API, and the program execution unit 102 is constituted so as to execute the program based on the same API. Therefore, the program acquired by the program acquisition unit 101 is executable by the program execution unit 102.

FIG. 18(b) is a block diagram illustrating an example of a specific construction of the conventional program acquisition and execution apparatus.

A computer 100a as a program acquisition and execution apparatus comprises a CPU 1001, a RAM 1002, a ROM 1003, and a communication interface 1004, and these elements are mutually connected through a bus 1005.

Further, the computer 100a and a file server 150a as a program storage apparatus are mutually connected through a communication path 200a as a communication medium.

The CPU 1001 in the computer 100a controls the communication interface 1004 by a program recorded in the ROM 1003, and outputs a command to the file server 150a.

The file server 150a searches for a program designated by the command, and sends the searched program to the computer 100a.

The communication interface 1004 of the computer 100a receives this program, and stores the program in the RAM 1002 as a work area.

The CPU 1001 executes the program obtained from the file server, under control of a monitor program such as an OS (Operating System) recorded in the ROM 1003.

To be specific, the section comprising the CPU 1001, the ROM 1003, and the communication interface 1004 corresponds to the program acquisition unit 101 shown in FIG. 18(a). Further, the section comprising the CPU 1001, the RAM 1002, and the ROM 1003 corresponds to the program execution unit 102.

By the way, in the conventional program acquisition apparatus using the technique disclosed in the non-patent document 1, it is determined that a new version API is provided so as to include an old version API in the new version API. Therefore, even when the version of the API of the program acquired by the program acquisition unit 101 is older than the version with which the program execution unit 102 complies, the acquired program can be executed without problems.

To be specific, when executing a single program, upper compatibility of the API version can be realized by using the technique disclosed in the non-patent document 1.

FIG. 19 illustrates the construction of a specific system for acquiring and executing such program, taking as an example HAVi (Home Audio/Video interoperability) which is a home network.

In this example, a TV receiver 100b as a program acquisition and execution apparatus and a VTR 150b as a program storage apparatus are connected to each other via an IEEE1394 cable 200b as a communication medium.

To be specific, in this home network, the TV receiver 100b and the VTR 150b operate cooperatively with each other to display a video source reproduced by the VTR 150b on the TV receiver 100b.

In order to realize such cooperative operation, a control program for the TV receiver 100b is prepared for each model on the VTR 150b side, and the TV receiver 100b and the VTR 150b start to exchange data at a timing when the TV receiver 100b and the VTR 150b are connected through the IEEE1394 cable 200b, whereby a program according to the type of the TV receiver 100b is downloaded from the VTR 150b side.

Thereby, the TV receiver 100b can execute the control program that is most suitable for the corresponding model to operate cooperatively with the VTR 150b.

In the conventional construction described above, however, if a program complying with a new API and a program complying with an old API are mixed when plural programs are acquired and executed while mutually utilizing the other program, even when it is tried to utilize a function possessed by the program complying with the old version API from the program complying with the new version API, only the old version API can be utilized.

More specifically, by using the technique disclosed in the non-patent literature 1, when the program execution unit 102 complies with the new version, the unit 102 can execute both the program complying with the new version API and the program complying with the old version API.

However, when a program utilizes another program, since the program complying with the old version API does not comply with the new version API, only the old version API can be utilized from the program complying with the new version API.

Furthermore, whether the API with which the program to be utilized complies is the new version API or the old version API can be found only when the program is executed.

Accordingly, the program complying with the new version API must check as to which version of API the other program to be utilized uses, for each program to be utilized, and utilizes the function possessed by the other program, using the API that is used by the other program.

Therefore, when plural programs are cooperatively operated, in order to make these programs executable as much as possible even if there is a mismatch between the versions of these programs, it is necessary for each program to possess codes using APIs that are older than the API used by each program, for each API of the older version, in a position where each program utilizes the function of the other program, leading to complexity of the program structures and increase in the program sizes.

Furthermore, conversely, even when the program complying with the old version tries to utilize the program complying with the new version, the program complying with the old version cannot know what function is added to the program complying with the new version. Therefore, it is usually impossible to prepare codes corresponding to the API of the version later than the version of itself, and consequently, the API of the version later than itself cannot be utilized in the first place.

The present invention is made to solve the above-mentioned problems and has for its object to provide a program acquisition and execution apparatus, a program acquisition and execution method, a program acquisition and execution program storage medium, and a program acquisition and execution program by which, when plural programs are acquired and operated cooperatively, even if there is a mismatch in versions of these programs, a program can utilize another program without the necessity of preparing different codes for the respective versions of programs to be utilized, and further, by which a program complying with an old version can utilize a program complying with a new version.

Furthermore, it is another object of the present invention to provide a program acquisition and execution apparatus, a program acquisition and execution method, a program acquisition and execution program storage medium, and a program acquisition and execution program which can resolve not only a mismatch in API versions between plural programs as described above but also overall mismatches in communication modes between plural programs.

That is, the present invention has for its object to provide a program acquisition and execution apparatus, a program acquisition and execution method, a program acquisition and execution program storage medium, and a program acquisition and execution program by which, when plural programs are acquired and operated cooperatively, even if there is a mismatch in communication modes between the programs, a program can utilize another program without the necessity of preparing different codes for the respective types of communication modes that can be used by the programs to be utilized.

### Measures to Solve the Problems

In order to solve the conventional problems, according to claim 1 of the present invention, there is provided a program acquisition and execution apparatus for acquiring programs from a program storage apparatus through a communication medium, and executing the programs, and the apparatus comprises a program acquisition unit for acquiring programs from the program storage apparatus, a program execution unit for executing the programs that are acquired by the program acquisition unit, and a communication mode conversion unit for converting communication modes at performing mutual communication between the plural programs being executed by the program execution unit.

According to claim 2 of the present invention, there is provided a program acquisition and execution apparatus for acquiring programs from a program storage apparatus through a communication medium, and executing the programs, and the apparatus comprises a program acquisition unit for acquiring programs from the program storage apparatus, a program execution unit for executing the programs that are acquired by the program acquisition unit, and a communication mode mismatch detection unit for detecting a mismatch in communication modes when the plural programs being executed by the program execution unit communicate with each other.

According to claim 3 of the present invention, in the program acquisition and execution apparatus defined in claim 2, when the communication mode mismatch detection unit detects a mismatch in communication modes, the program acquisition unit reacquires a program.

According to claim 4 of the present invention, the program acquisition and execution apparatus defined in claim 2 or 3 further includes a communication mode conversion unit for converting a communication mode at performing mutual communication between plural programs being executed by the program execution unit, when the communication mode mismatch detection unit detects a mismatch in communication modes.

According to claim 5 of the present invention, the program acquisition and execution apparatus defined in claim 3 or 4 further includes a matched communication mode determination unit for determining a matched communication mode to be used by the program reacquired by the program acquisition unit, and the program acquisition unit reacquires the program which uses the communication mode determined by the matched communication mode determination unit.

According to claim 6 of the present invention, in the program acquisition and execution apparatus defined in claim 5, the matched communication mode determination unit determines a matched communication mode from among communication modes which are used by the programs that have already been acquired by the program acquisition unit.

According to claim 7 of the present invention, in the program acquisition and execution apparatus defined in claim 5, the matched communication mode determination unit determines a matched communication mode from among communication modes which are used by programs that can be reacquired from one or plural program storage apparatuses.

According to claim 8 of the present invention, in the program acquisition and execution apparatus defined in any of claims 5 to 7, the matched communication mode determination unit selects a latest communication mode from among candidates of matched communication modes, and determines it as a matched communication mode.

According to claim 9 of the present invention, in the program acquisition and execution apparatus defined in any of claims 5 to 7, the matched communication mode determination unit selects a communication mode which minimizes the cost required when the program acquisition unit reacquires the program, and determines it as a matched communication mode.

According to claim 10 of the present invention, in the program acquisition and execution apparatus defined in any of claims 5 to 9, when the program acquisition unit fails in acquisition of a program which uses the matched communication mode that is determined by the matched communication mode determination unit, the matched communication mode determination unit redetermines a matched communication mode, and the program acquisition unit reacquires a program which uses the communication mode that is redetermined by the matched communication mode determination unit.

According to claim 11 of the present invention, the program acquisition and execution apparatus defined in any of claims 5 to 10 further includes a communication mode determining method indication unit for indicating a method by which the communication mode determination unit determines a matched communication mode, and the communication mode determination unit determines a matched communication mode by the method that is indicated by the communication mode determining method indication unit.

According to claim 12 of the present invention, in the program acquisition and execution apparatus defined in any of claims 5 to 11, the program acquisition unit reacquires only a program for which the communication mode mismatch detection unit detects a mismatch in the communication mode thereof.

According to claim 13 of the present invention, in the program acquisition and execution apparatus defined in any of claims 5 to 11, the program acquisition unit reacquires all programs which are required to be executed by the program execution unit.

According to claim 14 of the present invention, in the program acquisition and execution apparatus defined in any of claims 5 to 13, the program acquisition unit reacquires only a portion of a program, where a mismatch in communication modes which is detected by the communication mode mismatch detection unit exists.

According to claim 15 of the present invention, in the program acquisition and execution apparatus defined in any of claims 1, 4 to 14, the communication mode conversion unit converts a communication mode by executing a conversion program for performing conversion of a communication mode, and the program acquisition unit acquires the conversion program to be executed by the communication mode conversion unit.

According to claim 16 of the present invention, the program acquisition and execution apparatus defined in any of claims 1, 4 to 15 further includes a communication mode conversion method indication unit for indicating a method by which the communication mode conversion unit converts the communication mode, and the communication mode conversion unit converts the communication mode by the method indicated by the communication mode conversion method indication unit.

According to claim 17 of the present invention, the program acquisition and execution apparatus defined in any of claims 1 to 16 further includes a program acquisition method indication unit for indicating a method by which the program acquisition unit acquires programs, and the program acquisition unit acquires the programs by the method indicated by the program acquisition method indication unit.

According to claim 18 of the present invention, in the program acquisition and execution apparatus defined in any of claims 2 to 17, the communication mode mismatch detection unit detects a mismatch in communication modes before the program execution unit starts execution of programs.

According to claim 19 of the present invention, in the program acquisition and execution apparatus defined in any of claims 2 to 17, the communication mode mismatch detection unit successively detects mismatches in communication modes while the program execution unit is executing programs.

According to claim 20 of the present invention, the program acquisition and execution apparatus defined in any of claims 3 to 19 further includes a program storage unit which stores a program to be reacquired by the program acquisition unit or a portion of the program, and the program execution unit executes the program that is reacquired by the program reacquisition unit or a portion of the program, and thereafter, reexecutes the program that is stored in the program storage unit.

According to claim 21 of the present invention, there is provided a program acquisition and execution method for acquiring programs from a program storage apparatus through a communication medium and executing the programs, and the method comprises a program acquisition step of acquiring programs from the program storage apparatus, a program execution step of executing the programs that are acquired in the program acquisition step, and a communication mode conversion step of converting communication modes at performing mutual communication between plural programs being executed by the program execution step.

According to claim 22 of the present invention, there is provided a program acquisition and execution method for acquiring programs from a program storage apparatus through a communication medium, and executing the programs, and the method comprises a program acquisition step of acquiring programs from the program storage apparatus, a program execution step of executing the programs that are acquired in the program acquisition step, and a communication mode mismatch detection step of detecting a mismatch in communication modes when plural programs being executed by the program execution unit communicate with each other.

According to claim 23 of the present invention, there is provided a medium which stores a program for making a computer execute a program acquisition and execution method for acquiring programs from a program storage apparatus through a communication medium and executing the programs, and the program acquisition and execution method comprises a program acquisition step of acquiring programs from the program storage apparatus, a program execution step of executing the programs that are acquired in the program acquisition step, and a communication mode conversion step of converting communication modes at performing mutual communication between plural programs being executed by the program execution step.

According to claim 24 of the present invention, there is provided a medium which stores a program for making a computer execute a program acquisition and execution method for acquiring programs from a program storage apparatus through a communication medium and executing the programs, and the program acquisition and execution method comprises a program acquisition step of acquiring programs from the program storage apparatus, a program execution step of executing the programs that are acquired in the program acquisition step, and a communication mode mismatch detection step of detecting a mismatch in communication modes when plural programs being executed by the program execution unit communicate with each other.

According to claim 25 of the present invention, there is provided a program which makes a computer execute a program acquisition and execution method for acquiring programs from a program storage apparatus through a communication medium and executing the programs, and the program acquisition and execution method comprises a program acquisition step of acquiring programs from the program storage apparatus, a program execution step of executing the programs that are acquired in the program acquisition step, and a communication mode conversion step of converting communication modes at performing mutual communication between plural programs being executed by the program execution step.

According to claim 26 of the present invention, there is provided a program which makes a computer execute a program acquisition and execution method for acquiring programs from a program storage apparatus through a communication medium and executing the programs, and the program acquisition and execution method comprises a program acquisition step of acquiring programs from the program storage apparatus, a program execution step of executing the programs that are acquired in the program acquisition step, and a communication mode mismatch detection step of detecting a mismatch in communication modes when plural programs being executed by the program execution unit communicate with each other.

### EFFECTS OF THE INVENTION

According to the program acquisition and execution apparatus defined in claim 1, even if there is a mismatch in communication modes that can be used by plural programs when the plural programs are acquired and operated cooperatively, the plural programs can be made to communicate with each other by converting the communication modes for the mutual communication of the plural programs.

According to the program acquisition and execution apparatus defined in claim 2, even if there is a mismatch in communication modes that can be used by plural programs when the plural programs are acquired and operated cooperatively, a necessary measure can be taken by detecting the mismatch.

According to the program acquisition and execution apparatus defined in claim 3, in addition to the effect achieved by the program acquisition and execution apparatus defined in claim 2, the plural programs can be executed in combinations having no mismatch by reacquiring the programs in which the mismatch is detected.

According to the program acquisition and execution apparatus defined in claim 4, in addition to the effect achieved by the program acquisition and execution apparatus defined in claim 2 or 3, the plural programs can be made to communicate with each other by converting the communication modes of the programs in which the mismatch is detected.

According to the program acquisition and execution apparatus defined in claim 5, in addition to the effect achieved by the program acquisition and execution apparatus defined in claim 3 or 4, the plural programs can be made to communicate with each other by reacquiring programs that use a matched communication mode, for the programs in which the mismatch is detected.

According to the program acquisition and execution apparatus defined in claim 6, in addition to the effect achieved by the program acquisition and execution apparatus defined in claim 5, the plural programs can be made to communicate with each other by determining a matched communication mode from among communication modes that can be used by the plural programs, and reacquiring programs that use the matched communication mode.

According to the program acquisition and execution apparatus defined in claim 7, in addition to the effect achieved by the program acquisition and execution apparatus defined in claim 5, the plural programs can be made to communicate each other by determining a matched communication mode from among communication modes which are used by programs that can be reacquired from the program storage unit, and reacquiring programs that use the matched communication mode.

According to the program acquisition and execution apparatus defined in claim 8, in addition to the effect achieved by the program acquisition and execution apparatus defined in any of claims 5 to 7, the plural programs can be made to communicate with each other by using a communication mode that is as new as possible.

According to the program acquisition and execution apparatus defined in claim 9, in addition to the effect achieved by the program acquisition and execution apparatus defined in any of claims 5 to 7, the cost for performing reacquisition to make the plural programs communicate with each other can be reduced as much as possible.

According to the program acquisition and execution apparatus defined in claim 10, in addition to the effect achieved by the program acquisition and execution apparatus defined in any of claims 5 to 9, even when the program acquisition and execution apparatus fails in reacquisition of programs which use a communication mode that is determined as a matched communication mode, the plural programs can be made to communicate with each other by redetermining a matched communication mode, and reacquiring programs that use the redetermined matched communication mode.

According to the program acquisition and execution apparatus defined in claim 11, in addition to the effect achieved by the program acquisition and execution apparatus defined in any of claims 5 to 10, the user can selects a method for determining a matched communication mode, and programs which use the matched communication mode that is determined by the method selected by the user are reacquired, thereby enabling the plural programs to communicate with each other.

According to the program acquisition and execution apparatus defined in claim 12, in addition to the effect achieved by the program acquisition and execution apparatus defined in any of claims 5 to 10, efficient reacquisition of programs can be realized by reacquiring not all the plural programs but only programs in which a mismatch is detected.

According to the program acquisition and execution apparatus defined in claim 13, in addition to the effect achieved by the program acquisition and execution apparatus defined in any of claims 5 to 11, since all the plural programs are reacquired, it is possible to avoid occurrence of further mismatch which may be caused by that only portions of the plural programs are acquired.

According to the program acquisition and execution apparatus defined in claim 14, in addition to the effect achieved by the program acquisition and execution apparatus defined in any of claims 5 to 13, the cost for reacquisition can be minimized by reacquiring only portions of programs where a mismatch in communication modes exists.

According to the program acquisition and execution apparatus defined in claim 15, in addition to the effect achieved by the program acquisition and execution apparatus defined in any of claim 1 and claims 4 to 14, since the communication mode for mutual communication of the plural programs is converted according to a conversion program that is obtained from the program storage apparatus, it is possible to change the conversion method itself for converting the communication mode at performing the mutual communication between the plural programs.

According to the program acquisition and execution apparatus defined in claim 16, in addition to the effect achieved by the program acquisition and execution apparatus defined in any of claim 1 and claims 4 to 15, the user can select a method for converting communication modes, and the communication mode at performing mutual communication between the plural programs is converted according to the method selected by the user, thereby enabling the plural program to communicate with each other.

According to the program acquisition and execution apparatus defined in claim 17, in addition to the effect achieved by the program acquisition and execution apparatus defined in any of claims 1 to 16, the user can select a method for acquiring programs, and programs in which a mismatch is detected is reacquired according to the method selected by the user, thereby enabling the plural programs to communicate with each other.

According to the program acquisition and execution apparatus defined in claim 18, in addition to the effect achieved by the program acquisition and execution apparatus defined in any of claims 2 to 17, since a mismatch in communication modes is detected before program execution is started, reacquisition or reexecution of programs during program execution can be avoided.

According to the program acquisition and execution apparatus defined in claim 19, in addition to the effect achieved by the program acquisition and execution apparatus defined in any of claims 2 to 17, since mismatches in communication modes are successively detected during program execution, delay in execution start due to detection of mismatches before program execution can be avoided.

According to the program acquisition and execution apparatus defined in claim 20, in addition to the effect achieved by the program acquisition and execution apparatus defined in any of claims 3 to 19, since the original programs in which a mismatch is detected are stored and programs that use a matched communication mode are reacquired and executed with respect to the original programs, the original programs can be executed after resolving the mismatch in communication modes.

According to the program acquisition and execution method defined in claim 21, when plural programs are acquired and operated cooperatively, even if there is a mismatch in communication modes that can be used by the plural programs, it is possible to make the plural programs communicate with each other by converting the communication modes at performing the mutual communication between the plural programs.

According to the program acquisition and execution method defined in claim 22, even if there is a mismatch in communication modes that can be used by plural programs when the plural programs are acquired and operated cooperatively, a necessary measure can be taken by detecting the mismatch.

According to the program acquisition and execution program recording medium defined in claim 23, when plural programs are acquired and operated cooperatively, even if there is a mismatch in communication modes that can be used by the plural programs, it is possible to make the plural programs communicate with each other by converting the communication modes at performing the mutual communication between the plural programs.

According to the program acquisition and execution program recording medium defined in claim 24, even if there is a mismatch in communication modes that can be used by plural programs when the plural programs are acquired and operated cooperatively, a necessary measure can be taken by detecting the mismatch.

According to the program acquisition and execution program defined in claim 25, even if there is a mismatch in communication modes that can be used by plural programs when the plural programs are acquired and operated cooperatively, the plural programs can be made to communicate with each other by converting the communication modes at performing the mutual communication between the plural programs.

According to the program acquisition and execution program defined in claim 26, even if there is a mismatch in communication modes that can be used by plural programs when the plural programs are acquired and operated cooperatively, a necessary measure can be taken by detecting the mismatch.

### BRIEF DESCRIPTION OF THE DRAWINGS

FIG. 1(a) is a block diagram illustrating a program acquisition and execution apparatus according to a first embodiment of the present invention.

FIG. 1(b) is a diagram illustrating a hierarchical structure of the program acquisition and execution apparatus according to the first embodiment of the present invention.

FIG. 1(c) is a diagram illustrating a hierarchical structure of the program acquisition and execution apparatus according to the first embodiment of the present invention.

FIG. 1(d) is a diagram illustrating a hierarchical structure of the program acquisition and execution apparatus according to the first embodiment of the present invention.

FIG. 1(e) is a diagram illustrating a program file structure of the program acquisition and execution apparatus according to the first embodiment of the present invention.

FIG. 1(f) is a diagram illustrating a flowchart of an API converting operation of the program acquisition and execution apparatus according to the first embodiment of the present invention.

FIG. 1(g) is a schematic diagram illustrating an operation for detecting a mismatch in API versions, of the program acquisition and execution apparatus according to the first embodiment of the present invention.

FIG. 1(h) is a block diagram illustrating a construction of a system including the program acquisition and execution apparatus according to the first embodiment of the present invention.

FIG. 2(a) is a block diagram illustrating a construction of a mobile phone as a variation of the first embodiment of the present invention.

FIG. 2(b) is a block diagram illustrating a construction of a system that performs program updation for the mobile phone as the variation of the first embodiment.

FIG. 2(c) is a diagram illustrating a flowchart of an operation of a server shown in FIG. 2(b).

FIG. 2(d) is a diagram illustrating a flowchart of an operation of the mobile phone shown in FIG. 2(b).

FIG. 2(e) is a diagram illustrating a state where the mobile phone displays an updation program list.

FIG. 2(f) is a diagram illustrating a state where the updation program list of the mobile phone shown in FIG. 2(b) is selected.

FIG. 2(g) is a diagram illustrating an example of a data structure of an updation wish list of the mobile phone shown in FIG. 2(b).

FIG. 2(h) is a diagram illustrating a flowchart of the operation of the server shown in FIG. 2(b).

FIG. 2(i) is a diagram illustrating a flowchart of the operation of the mobile phone shown in FIG. 2(b).

FIG. 3(a) is a block diagram illustrating a program acquisition and execution apparatus according to a second embodiment of the present invention.

FIG. 3(b) is a diagram illustrating a data structure of a program file according to the second embodiment of the present invention.

FIG. 3(c) is a diagram illustrating a data structure of a data file according to the second embodiment of the present invention.

FIG. 4 is a block diagram illustrating a program acquisition and execution apparatus according to a third embodiment of the present invention.

FIG. 5 is a block diagram illustrating a program acquisition and execution apparatus according to a fourth embodiment of the present invention.

FIG. 6 is a block diagram illustrating a program acquisition and execution apparatus according to fifth to tenth embodiments of the present invention.

FIG. 7 is a diagram illustrating a flowchart for explaining the outline of the operation of the program acquisition and execution apparatus according to the first embodiment of the present invention.

FIG. 8 is a diagram illustrating examples of APIs which are used by programs to be executed by a program execution unit in the program acquisition and execution apparatus according to the first embodiment of the present invention.

FIG. 9(a) is a diagram illustrating an example of communication mode conversion by a communication mode conversion unit in the program acquisition and execution apparatus according to the first embodiment of the present invention.

FIG. 9(b) is a diagram illustrating a construction when the communication mode conversion unit of the program acquisition and execution apparatus according to the first embodiment is implemented by a communication mode conversion program.

FIG. 9(c) is a diagram illustrating an example of a conversion table which is used when the communication mode conversion unit of the program acquisition and execution apparatus according to the first embodiment is implemented by a communication mode conversion program.

FIG. 10 is a diagram illustrating a flowchart for explaining the outline of the operation of the program acquisition and execution apparatus according to the second embodiment of the present invention.

FIG. 11(a) is a diagram illustrating a flowchart for explaining the outline of the operation of the program acquisition and execution apparatus according to the third embodiment of the present invention.

FIG. 11(b) is a diagram illustrating a flowchart of an example of specific processing in step S26 shown in FIG. 11(a).

FIG. 12 is a diagram illustrating a flowchart for explaining the outline of the operation of the program acquisition and execution apparatus according to the fourth embodiment of the present invention.

FIG. 13(a) is a diagram illustrating a flowchart for explaining the outline of the operation of the program acquisition and execution apparatus according to the fifth embodiment of the present invention.

FIG. 13(b) is a diagram illustrating a flowchart of an example of specific processing in step S59 shown in FIG. 13(a).

FIG. 13(c) is a diagram illustrating an example of a table showing upper compatibilities of communication modes used in step S59 in FIG. 13(a).

FIG. 13(d) is a diagram illustrating a specific flowchart of the processing performed by the program acquisition and execution apparatus according to the sixth embodiment of the present invention.

FIG. 13(e) is a diagram illustrating a specific flowchart of the processing performed by the program acquisition and execution apparatus according to the seventh embodiment of the present invention.

FIG. 13(f) is a diagram illustrating a specific flowchart of the processing performed by the program acquisition and execution apparatus according to the eighth embodiment of the present invention.

FIG. 13(g) is a diagram illustrating a table showing newnesses of communication modes used in the program acquisition and execution apparatus according to the eighth embodiment of the present invention.

FIG. 13(h) is a diagram illustrating a specific flowchart of the processing performed by the program acquisition and execution apparatus according to the ninth embodiment of the present invention.

FIG. 13(i) is a diagram illustrating another example of a data structure of the program file to be used in step S596c in FIG. 13(h).

FIG. 13(j) is a diagram illustrating another example of a data structure of the program file to be used in step S596c in FIG. 13(h).

FIG. 13(k) is a diagram illustrating a flowchart for explaining the outline of the operation of the program acquisition and execution apparatus according to the tenth embodiment of the present invention.

FIG. 14(a) is a block diagram illustrating a program acquisition and execution apparatus according to eleventh fifteenth embodiments of the present invention.

FIG. 14(b) is a diagram illustrating a flowchart for explaining the outline of the operation of the program acquisition and execution apparatus according to the eleventh embodiment of the present invention.

FIG. 14(c) is a diagram illustrating a flowchart for explaining the outline of the operation of the program acquisition and execution apparatus according to the twelfth embodiment of the present invention.

FIG. 14(d) is a diagram illustrating a flowchart for explaining the outline of the operation of the program acquisition and execution apparatus according to the thirteenth embodiment of the present invention.

FIG. 14(e) is a diagram illustrating a flowchart for explaining the outline of the operation of the program acquisition and execution apparatus according to the fourteenth embodiment of the present invention.

FIG. 14(f) is a diagram illustrating a flowchart for explaining the outline of the operation of the program acquisition and execution apparatus according to the fifteenth embodiment of the present invention.

FIG. 15(a) is a block diagram illustrating a program acquisition and execution apparatus according to a sixteenth embodiment of the present invention.

FIG. 15(b) is a diagram illustrating a flowchart for explaining the outline of the operation of the program acquisition and execution apparatus according to the sixteenth embodiment of the present invention.

FIG. 16(a) is a block diagram illustrating a program acquisition and execution apparatus according to seventeenth to nineteenth embodiments of the present invention.

FIG. 16(b) is a diagram illustrating a flowchart for explaining the outline of the operation of the program acquisition and execution apparatus according to the seventeenth embodiment of the present invention.

FIG. 16(c) is a diagram illustrating a flowchart for explaining the outline of the operation of the program acquisition and execution apparatus according to the eighteenth embodiment of the present invention.

FIG. 16(d) is a diagram illustrating a flowchart for explaining the outline of the operation of the program acquisition and execution apparatus according to the nineteenth embodiment of the present invention.

FIG. 17(a) is a block diagram illustrating a program acquisition and execution apparatus according to a twentieth embodiment of the present invention.

FIG. 17(b) is a diagram illustrating a flowchart for explaining the outline of the operation of the program acquisition and execution apparatus according to the twentieth embodiment of the present invention.

FIG. 18(a) is a block diagram illustrating a conventional program acquisition and execution apparatus.

FIG. 18(b) is a diagram illustrating a more specific construction of the conventional program acquisition and execution apparatus.

FIG. 19 is a diagram illustrating a construction in a case where the conventional program acquisition and execution apparatus is applied to a home network.

### DESCRIPTION OF REFERENCE NUMERALS

100 . . . program acquisition and execution apparatus
101 . . . program acquisition unit
102 . . . program execution unit
150 . . . program storage apparatus
203 . . . communication mode conversion unit
304 . . . communication mode mismatch detection unit
605 . . . matched communication mode determination unit
1406 . . . communication mode determining method indication unit
1507 . . . communication mode converting method indication unit
1608 . . . program acquiring method indication unit
1709 . . . program storage unit

### BEST MODE TO EXECUTE THE INVENTION

Hereinafter embodiments of the present invention will be described with reference to the drawings.

### Embodiment 1

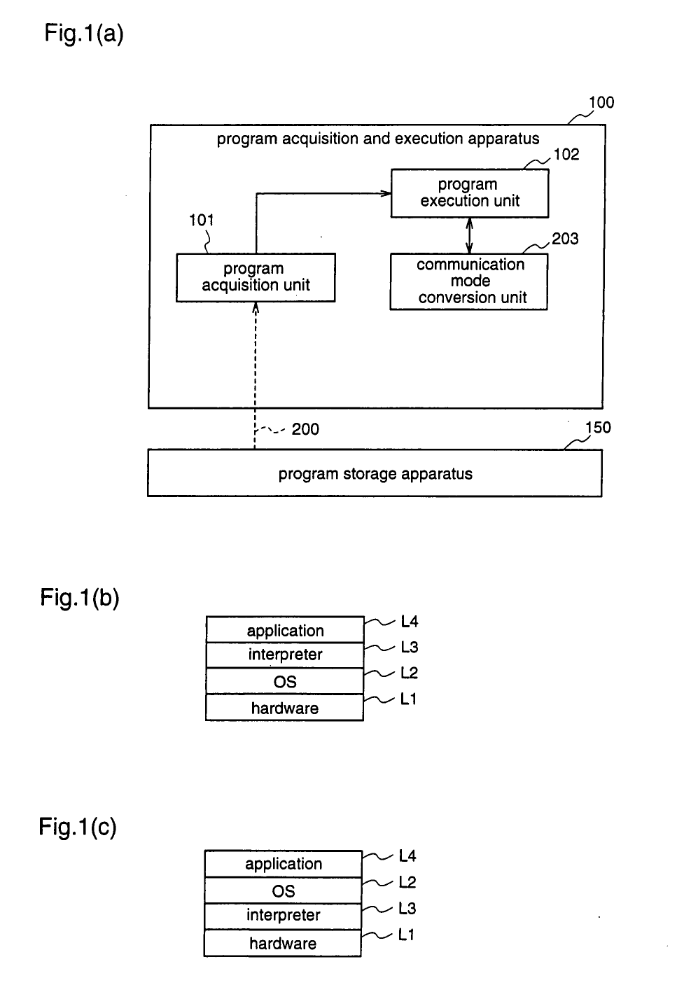

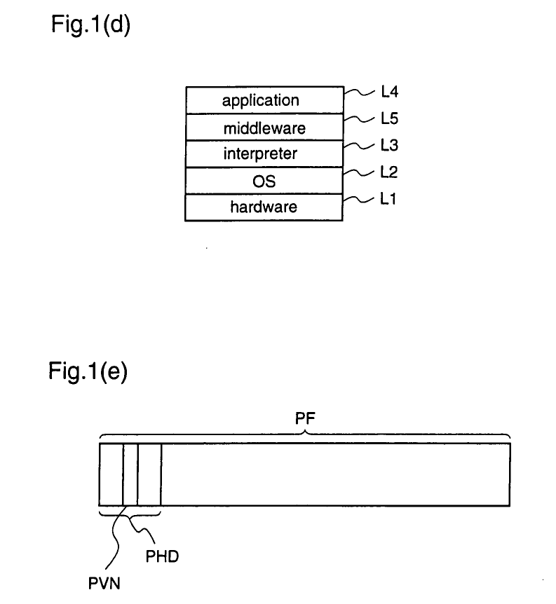

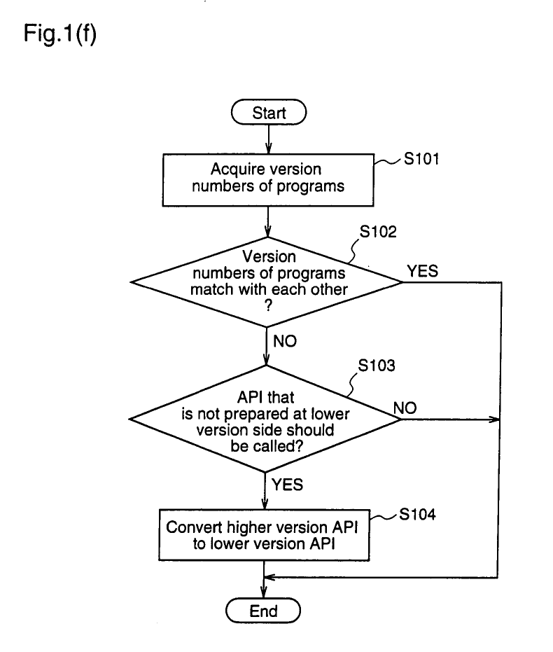

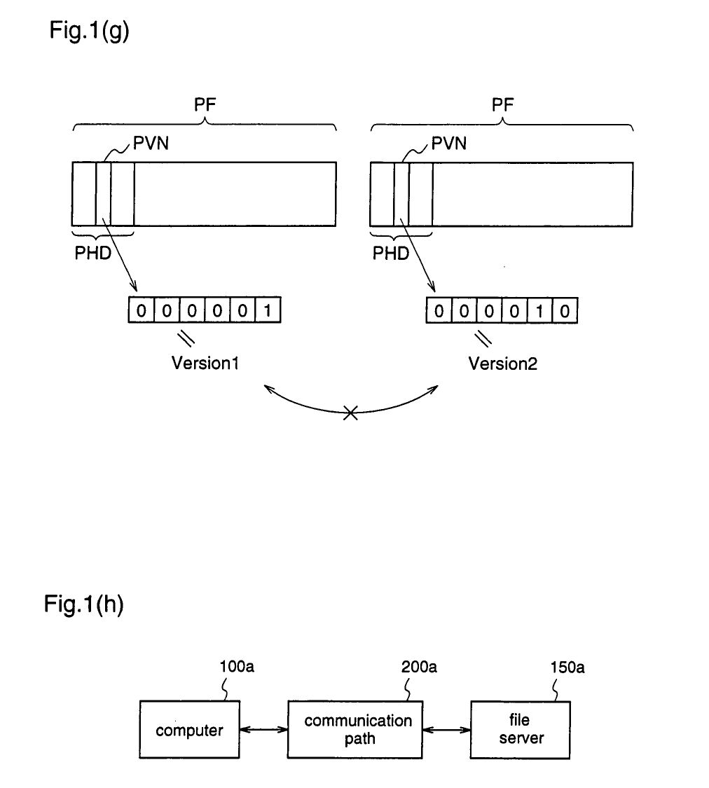

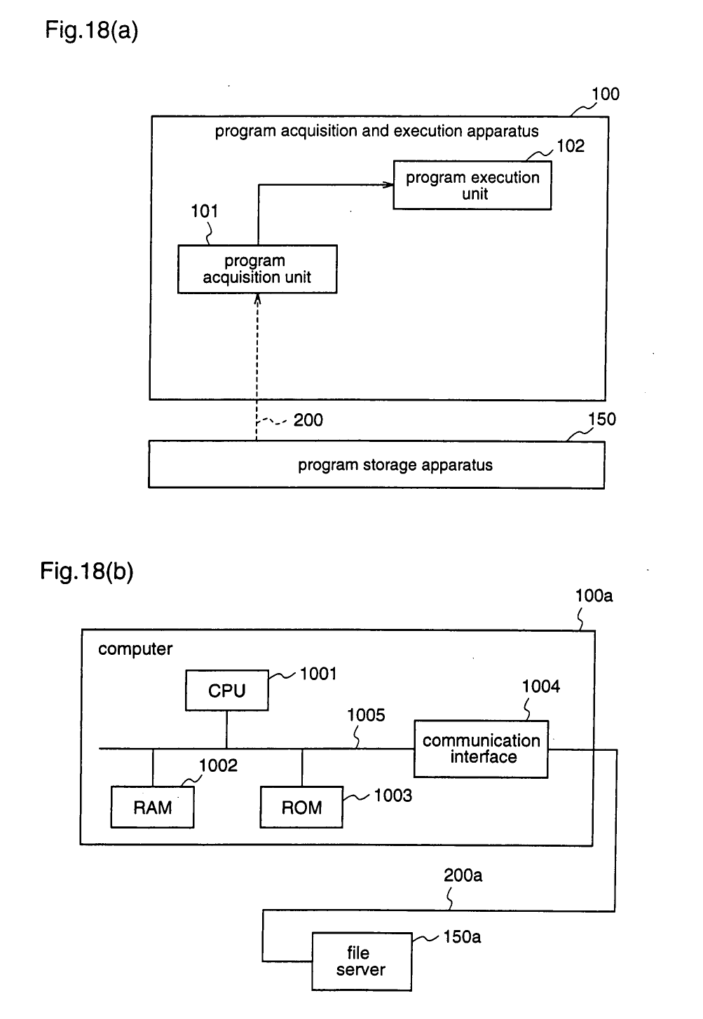

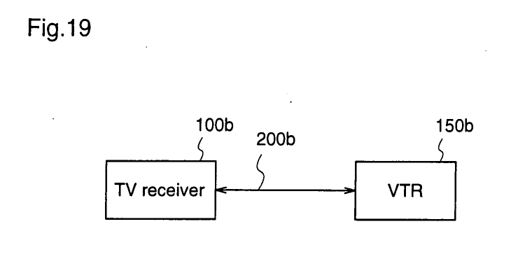

FIG. 1(a) is a block diagram illustrating a program acquisition and execution apparatus according to a first embodiment of the present invention. In FIG. 1(a), since the same reference numerals as those shown in FIG. 18(a) denote the same components, repeated description is not necessary.

With reference to FIG. 1(a), a program acquisition and execution apparatus 100 is provided with a communication mode conversion unit 203 in addition to the constituents shown in FIG. 18(a).

The communication mode conversion unit 203 comprises a communication mode conversion program recorded on a ROM 1003, a CPU 1001, and a RAM 1002 as a work area.

The communication mode conversion unit 203 converts the communication mode when plural programs executed by the program execution unit 102 mutually communicate.

It is assumed that the communication mode includes not only conversion of communication protocol but also conversion of API.

Further, it is assumed that communication between the programs includes calling of functions between the programs, and exchange of data between the programs.

FIGS. 1(b) to 1(d) show hierarchical structures of the program acquisition and execution apparatus.

As shown in FIG. 18(b), a hardware layer L1 includes a CPU 1001, a RAM 1002, a ROM 1003, and a communication interface 1004, and these components are mutually connected through a bus 1005 to constitute the hardware layer L1.

An OS layer L2 such as a realtime OS and a multitask OS is mounted on the hardware layer L1, and an interpreter layer L3 such as a Java™ virtual machine (VM) is mounted on the OS layer L2. An application layer L4 is mounted on the interpreter layer L3. As shown in FIG. 1(c), the OS layer L2 and the interpreter layer L3 may be reversed in the hierarchy. Further, as shown in FIG. 1(d), a middleware layer L5 may be inserted between the interpreter layer L3 and the application layer L4.

For example, the middleware corresponds to a program for communication processing or database management, and it provides a fundamental function that is surely required in a specific field such as communication processing or database management.

The hardware layer L1 is constituted by the whole hardware comprising the CPU 1001, the RAM 1002, the ROM 1003, and the communication interface 1004.

The OS layer L2, the interpreter layer L3, the application layer L4, and the middleware layer L5 comprise a monitor program such as an OS recorded on the ROM 1003, an interpreter such as Java™ virtual machine, an application, and a middleware program, respectively.

A program acquisition unit 101 comprises the monitor program recorded on the ROM 1003, the CPU 1001, and the communication interface 1004 controlled by the CPU 1001.

A program execution unit 102 comprises the monitor program recorded on the ROM 1003, the CPU 1001, and the RAM 1002 to be a work area.

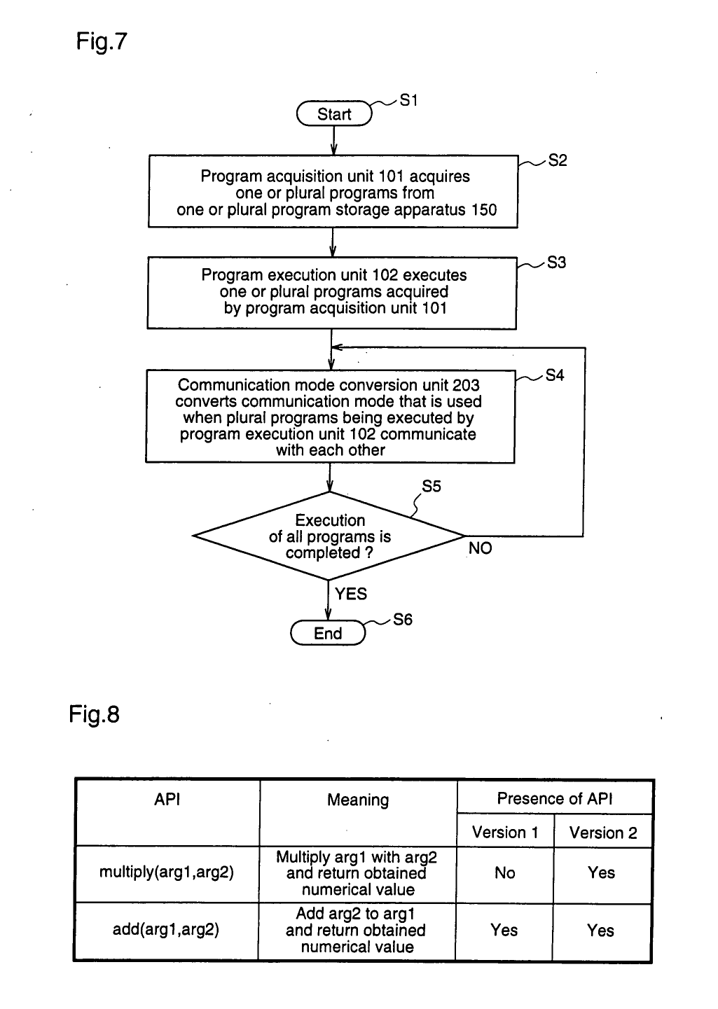

A description will be given of the outline of the operation of the program acquisition and execution apparatus 100 with reference to a flowchart shown in FIG. 7.

After processing is started (step S1), the program acquisition unit 101 acquires one or plural programs from one or plural program storage units 150 (step S2).

A communication medium 200 between the program storage unit 150 and the program acquisition and execution apparatus 100 and the program acquisition method have no relations to the claims of the present invention, and therefore, the claims of the present invention are not restricted by the communication medium between the program storage unit 150 and the program acquisition and execution apparatus 100 or the program acquisition method.

For example, specific communication media may include wired media such as a LAN (Local Area Network), a CATV (Cable TV) network, a FTTH (Fiber To The Home) network, and a fixed-line phone communication network, and wireless media such as an infrared communication interface, a Bluetooth™, a mobile communication network, and a satellite communication network.

The program execution unit 102 executes the one or plural programs acquired by the program acquisition unit 101 (step S3).

The communication mode conversion unit 203 converts the communication mode when the plural programs executed by the program execution unit 102 mutually communicate (step S4).

When execution of the one or plural programs performed by the program execution unit 102 is completed, the processing is ended (step S6). Otherwise, step S4 is repeated (step S5).

While in this first embodiment the communication mode conversion unit 203 repeats conversion of the communication mode until all the program executions are completed, the timing of conversion of the communication mode by the communication mode conversion unit 203 is not restricted to that of the first embodiment, and therefore, the claims of the present invention are not restricted by the timing of conversion of the communication mode.

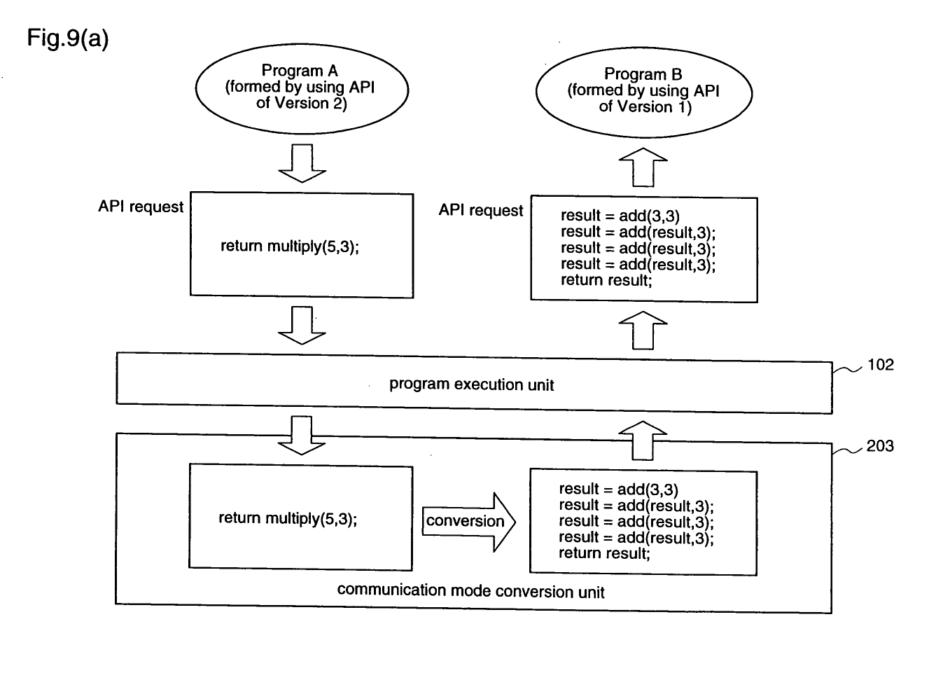

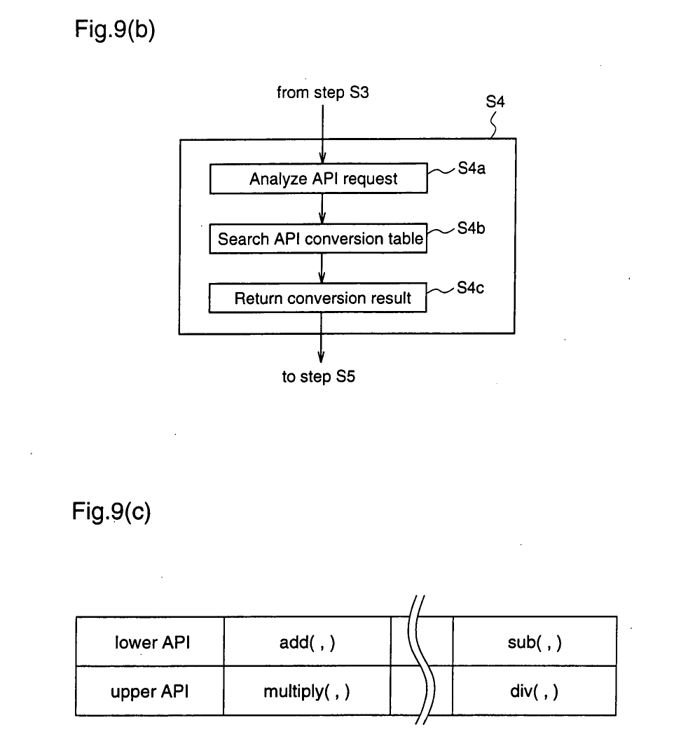

A description will be given of an example of conversion of the communication mode by the communication mode conversion unit 203, with reference to FIGS. 8 and 9.

FIG. 8 shows examples of APIs that are used by the programs to be executed by the program execution unit 102. In this example, there are two versions of APIs, “Version 1” and “Version 2”, as APIs used by the programs to be executed by the program execution unit 102. The “Version 2” is a program later than the “Version 1”, and the “Version 2” has upper compatibility with respect to the “Version 1”.

To be specific, the “Version 2” is obtained by enhancing the function of the “Version 1”, and moreover, it is compatible with the “Version 1”. For example, there are two APIs, “multiply” and “add”, and the “multiply” is newly added to the “Version 2”.

FIG. 8 shows an example of conversion of the communication mode by the communication mode conversion unit 203 in the case where the examples of APIs shown in FIG. 7 are used.

In this case, there are two programs, “Program A” and “Program B”, as programs to be executed by the program execution unit 102. The “Program A” is formed using the API of “Version 2” between the examples of APIs shown in FIG. 7, and the “Program B” is formed using the API of “Version 1”.

When the “Program A” using the API of “Version 2” makes an API request “multiply” which exists only in the API of “Version 2”, to the “Program B”, the “Program B” using the API of “Version 1” cannot interpret the API request to execute it.

So, the communication mode conversion unit 203 converts the API request of “multiply” into a combination of API requests “add” which is the API of “Version 1”, and sends the converted API request to the “Program B”. Thereby, communication between the “Program A” and the “Program B” which are formed using the different versions of APIs is realized.

As shown in FIG. 9(b), the communication mode conversion unit 203 analyzes the API request that is sent from the program execution unit 102, and separates it into a function (“multiply” in the example of FIG. 9(a)) and a parameter (“(5,3)” in the example of FIG. 9(a)) (step S4a). Next, the communication mode conversion unit 203 searches an API conversion table as shown in FIG. 9(c) on the basis of the function, thereby obtaining the API of the lower version (“add” in the example of FIG. 9(a)) which can convert the function (step S4b). Then, the communication mode conversion unit 203 generates a lower-version API request using the converted lower-version API and the parameter obtained in step S4a in FIG. 9(b), and returns this request as a conversion result to the program execution unit 102 (step S4c).

In this way, the conversion execution part in the communication mode conversion unit 203 can be implemented by describing it as a conversion program for an API to be converted using the API conversion table. However, the claims of the present invention are not restricted by the conversion execution method.

While in this example an expression similar to C language is adopted as an expression method for the contents of the API request, the expression method for the contents of the API request is not restricted to the expression of this example, and the claims of the present invention are not restricted by the API request expression method.

Further, while in this first embodiment programs having different versions of APIs, i.e., old and new versions of APIs, communicate with each other, the present invention can resolve not only a mismatch in API versions between plural programs but also a general mismatch in communication modes between plural programs.

To be specific, in the present invention, when plural programs are acquired and operated cooperatively, even if there is a mismatch in communication modes between the programs, the program acquisition and execution apparatus according to the present invention can utilize the other program without the necessity of preparing a different code for each type of communication mode that can be used by the other program to be utilized.

The API conversion shown in FIG. 8 may be carried out when a mismatch in APIs is detected on the basis of the version numbers of the programs, which are included in the headers of the programs.

That is, as shown in FIGS. 1(f) and 1(g), version numbers PVN are obtained from headers PHD of program files PF which perform communication with each other (step S101), and the version numbers are compared to check whether the version numbers match or not (step S102), and then it is determined as to whether an API that is not prepared for the lower version API should be called or not (step S103). When the API should be called, the higher version API is converted into the lower version API (step S104).

FIG. 1(h) illustrates an example of construction of a system in which a computer downloads and executes a program. In FIG. 1(h), a computer 100a as a program acquisition and execution apparatus makes an access to a file server 150a as a program storage unit through a communication path 200a as a communication medium, the file server 150a searches for a desired program designated by the computer 100a, the detected program is sent back as data to the computer 100a through the communication path 200a, and the computer 100a executes this program.

When there are plural programs which are downloaded as described above, and these programs calls APIs each other through inter-program communication, the above-mentioned conversion of communication mode is carried out if the versions of the APIs are different from each other.

Thereby, the programs which originally cannot perform mutual communication and therefore cannot perform cooperation or data exchange between them can perform mutual communication even when the programs have different versions of APIs. Therefore, it is not necessary to prepare a lower-version API, thereby preventing the programs from being complicated and from increasing in their sizes.

Further, also in this case, communication between programs may be realized by converting communication protocols when the programs have different communication protocols.

Furthermore, the first embodiment of the present invention is also applicable to automatic updation of programs not only in a computer and household electrical appliances corresponding to domestic network such as HAVi but also in internet-connectable household electrical appliances, appliances that are connectable to cable and radio communication network such as handy phones, and appliances that are connectable to broadcast networks such as television receivers and radio receivers.

### (Modification 1 of Embodiment 1)

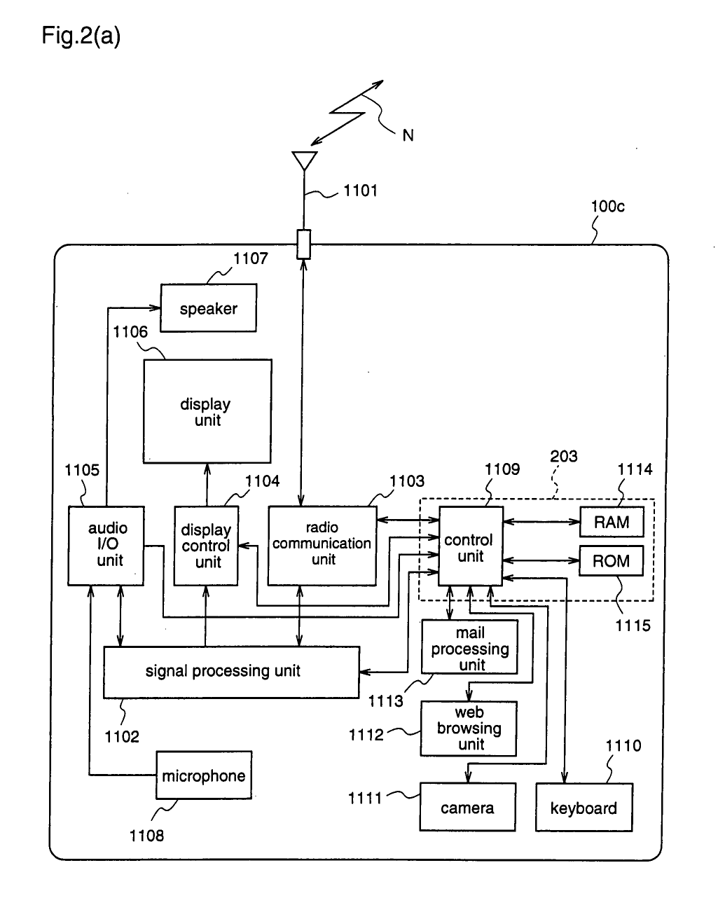

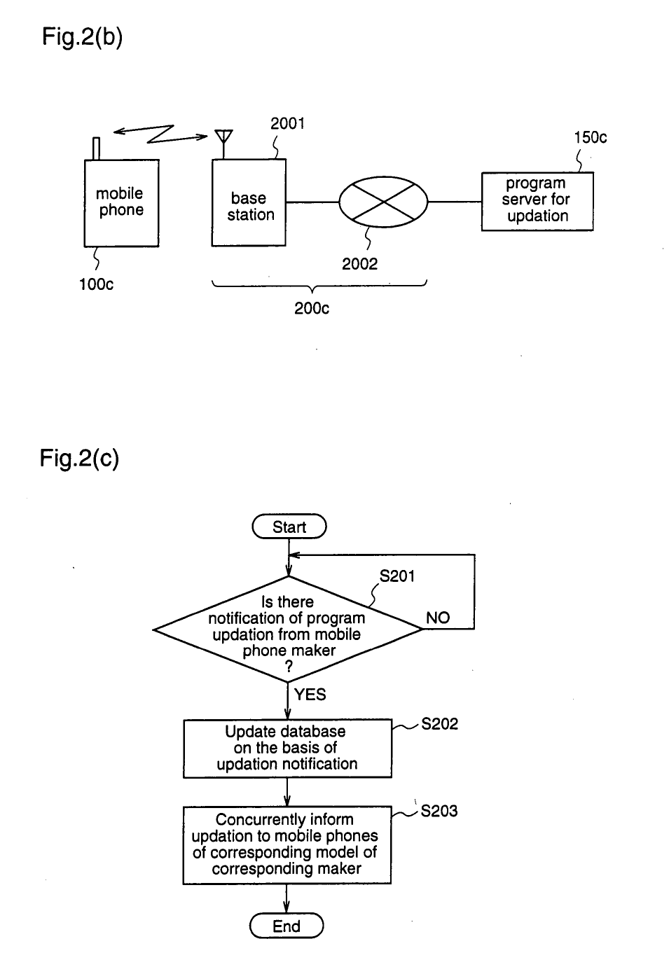

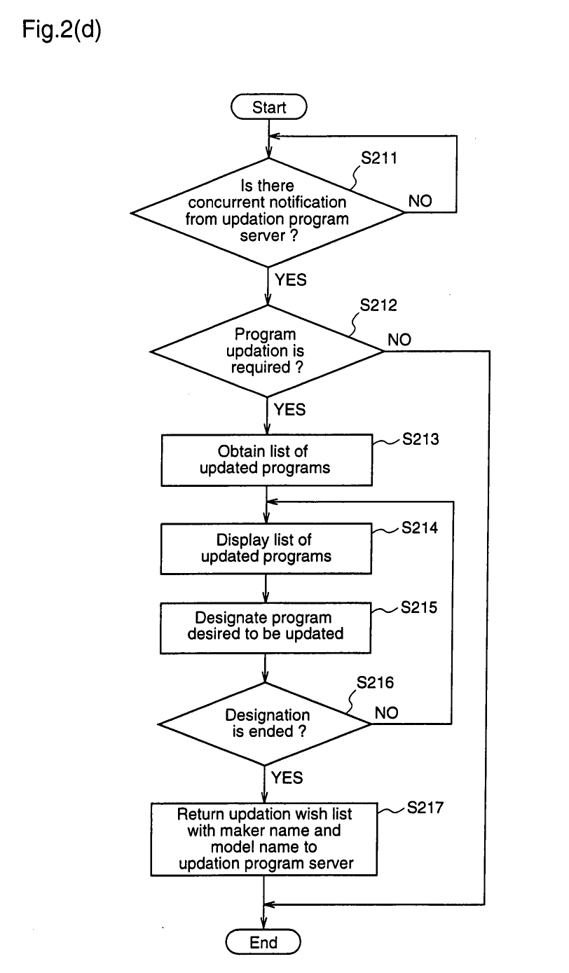

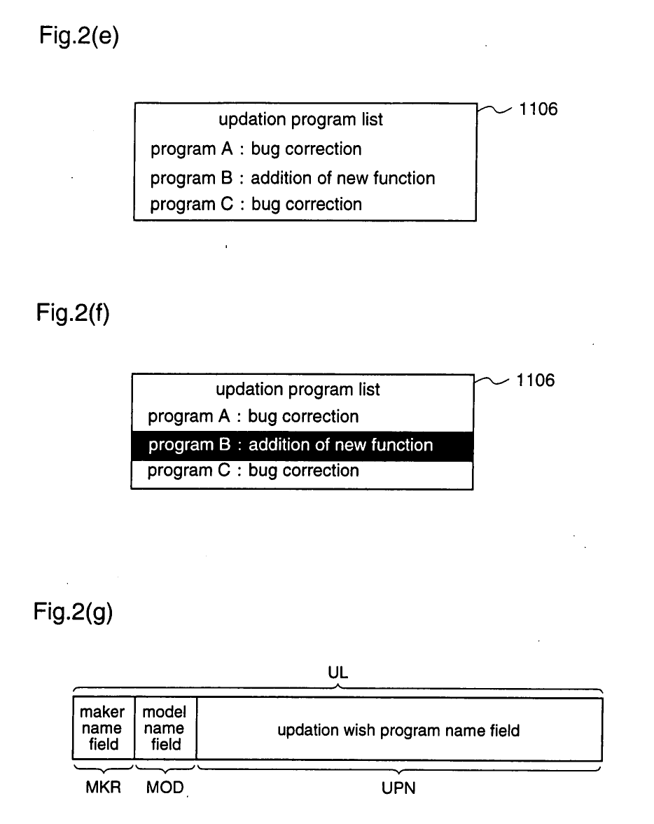

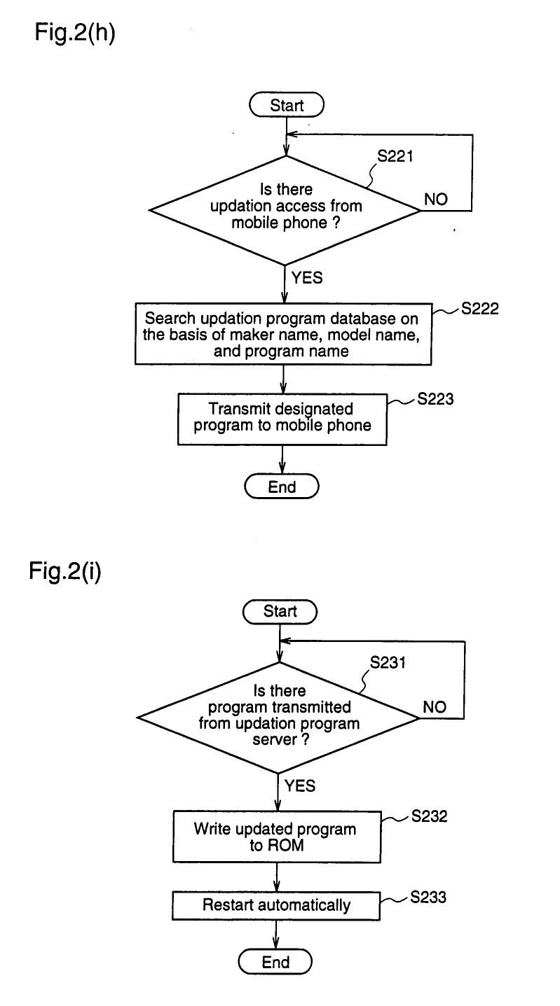

FIG. 2(a) is a block diagram illustrating an Internet-connectable mobile phone according to a first modification of the first embodiment.

The mobile phone 100c includes a signal processing unit 1102 for performing various kinds of signal processings, and a radio communication unit 1103 for outputting a radio signal N that is received as a reception signal by an antenna 1101, to the signal processing unit 1102, and transmitting a transmission signal generated by the signal processing unit 1102 as a radio signal N from the antenna 1101.

Further, the mobile phone 100c includes a display unit 1106 such as a liquid crystal panel (LCD) for performing image display, a microphone 108 for receiving sound, a speaker 1107 for reproducing an audio signal, a display control unit 1104 for receiving a video image signal processed by the signal processing unit 1102 and controlling the display unit 1106 so as to perform image display on the basis of the video signal, and an audio I/O unit 1105 for outputting the audio signal supplied from the microphone 1108 to the signal processing unit 1102, and outputting the audio signal processed by the signal processing unit 1112 to the speaker 1107.

Further, the mobile phone 100c includes a mail processing unit 113 which enables exchange of e-mails with other Internet-connectable mobile phones and personal computers according to mail addresses inputted by using a keyboard 1110 or the like, and therefore, the mobile phone 100c can transmit and receive e-mails including messages that are entered from the keyboard 1110 or image files that are taken by a camera 1111 at need as attached files. This is realized by a control unit 1109 which controls the respective units such that e-mail data generated by the mail processing unit 1113 are sent as electric wave by the radio communication unit 1103, and the e-mail data received by the radio communication unit 1103 are displayed under control of the display control unit 1104 to display the e-mail messages and the attached images on the display 1106.

A Web browsing unit 1112 requests data of a Web page (home page) specified by an URL (Uniform Resource Locator) entered from the keyboard 1110 or the like to a Web server (not shown) through the radio communication unit 1103. The Web server returns the data of the requested Web page. The Web browsing unit 1112 interprets the Web page data returned from the Web server, and the control unit 1109 controls the respective units so that the Web page is displayed on the display unit 1106 by the display control unit 1104, thereby realizing browsing of the Web page.

Further a ROM 1115 contains various kinds of applications such as games and calculators, and the control unit 1109 executes the applications according to operation of the keyboard 1110 or the like. A RAM 1114 is used as a work area or the like when the control unit 1109 executes various kinds of software.

As described above, the Internet-connectable mobile phone 100c implements the various functions thereof by software of the control unit 1109 corresponding to a CPU. However, since the software is fixed to the ROM, if bugs are discovered after shipping, there may occur cases where real machines should be called back for replacement.

So, in order to handle such bugs at low cost, a program in which the bugs are fixed (hereinafter referred to as an updation program) may be sent to the mobile phone to perform manual or automatic updation at the mobile phone end. The updation program has a version number higher than that of the software which is stored in the mobile phone at shipping.

FIG. 2(b) is a block diagram illustrating a software updation system for performing the above-mentioned updation, and FIGS. 2(c) to 2(i) are flowcharts for explaining an example of the software updating operation.

The mobile phone 100c and an updation program server 150c are connected through a communication network 200c comprising a base station 2001 and the Internet 2002.

First of all, as shown in FIG. 2(c), the updation program server 150c detects presence/absence of an updation notice from the mobile phone maker to recognize whether an updation program is prepared or not (step S201).

When an updation program is prepared, the updation program server 150c updates a database in which the updation program is stored, on the basis of the updation information of the maker (step S202). Thereafter, the updation program server 150c concurrently notifies the mobile phones of the corresponding maker and model that there has been program updation (step S203).

Next, as shown in FIG. 2(d), the mobile phone 100c detects whether there is a concurrent notification from the updation program server or not (step S211). When a concurrent notification is detected, the mobile phone 100c detects whether the user desires the program updation or not (step S212).

When the user enters that he/she desires the updation by keyboard operation or the like, the mobile phone 100c obtains a list of updated programs from the updation program server (step S213), and displays the list of updated programs on the display unit as shown in FIG. 2(e) (step S214).

The user refers to the updation program list displayed on the display unit, and specifies a program to be updated from the list by keyboard operation or the like (step s215). FIG. 2(f) shows the state where the program specified by the user is highlighted.

When the user has specified all the programs for which the user desires updation by repeating the above-mentioned operation (step S216), the mobile phone 100c transmits a list indicating the name of the maker, the name of the model, and the names of the programs desired to be updated, to the updation program server (step S217). FIG. 2(g) shows a list UL of the programs that are desired to be updated, wherein MKR is a field indicating the maker name of the mobile phone, and MOD is a field indicating the model name. Further, UPN is a field indicating the names of the programs that are desired to be updated, and a variable-length filed or a sufficiently large field is secured.

Next, as shown in FIG. 2(h), the updation program server 150c detects whether there is an updation access from the mobile phone 100c or not (step S221). When there is an updation access, the server 150c searches the database on the basis of the maker name, the model name, and the updation-desired program names which are transmitted from the mobile phone side (step S222), and returns the searched programs to the mobile phone side (step S223).

Next, as shown in FIG. 2(i), the mobile phone 100c detects whether there are updation programs returned from the updation program server 150c or not (step S231). When there are returned programs, the mobile phone 100c writes the updation programs into an electrically rewritable ROM (step S232), and automatically restarts the same according to need after writing is completed (step S233).

As described above, the mobile phone 100c transmits a command instructing program updation to the base station 2001, and the base station 2001 transmits this command to the updation program server 150c through the Internet 2002. The updation program server 150c searches for programs that are used by the mobile phone 100c and require updation, on the basis of the received command from the mobile phone 100c. The targets of this searching include OS, interpreter, middleware, and application.

Then, the updation program server 150c searches for the programs desired to be updated, and transmits the searched updation programs to the Internet 2002 through the base station 2001, and the base station 2001 returns the updation programs to the mobile phone 100c by radio wave.

Then, the mobile phone 100c overwrites the ROM 1115 with the returned updation programs, and restarting is carried out at need, whereby the updated programs can be executed.

However, even though bugs in each program can be resolved by this type of updation, since the plural programs operate in cooperation with each other, communication between the programs sometimes cannot be carried out due to differences in API versions or communication protocols.

So, an API that is not included in an API of lower version is converted into the lower version API, or the protocol is converted, whereby inter-program cooperation can be achieved when plural programs are simultaneously operated. In the case of the mobile phone 100c, the communication mode conversion unit 203 is composed of a program stored in the ROM 115, the control unit 1109, and the RAM 1114 as a work area.

As described above, according to the program acquisition and execution apparatus of the first embodiment, when the program execution unit 102 acquires plural programs and makes the programs operate cooperatively, even if there is a mismatch in communication modes that can be used by the plural programs, since the communication mode conversion unit 203 converts the communication modes at performing mutual communication between the plural programs, it is possible to make the plural programs perform mutual communication.

### Embodiment 2

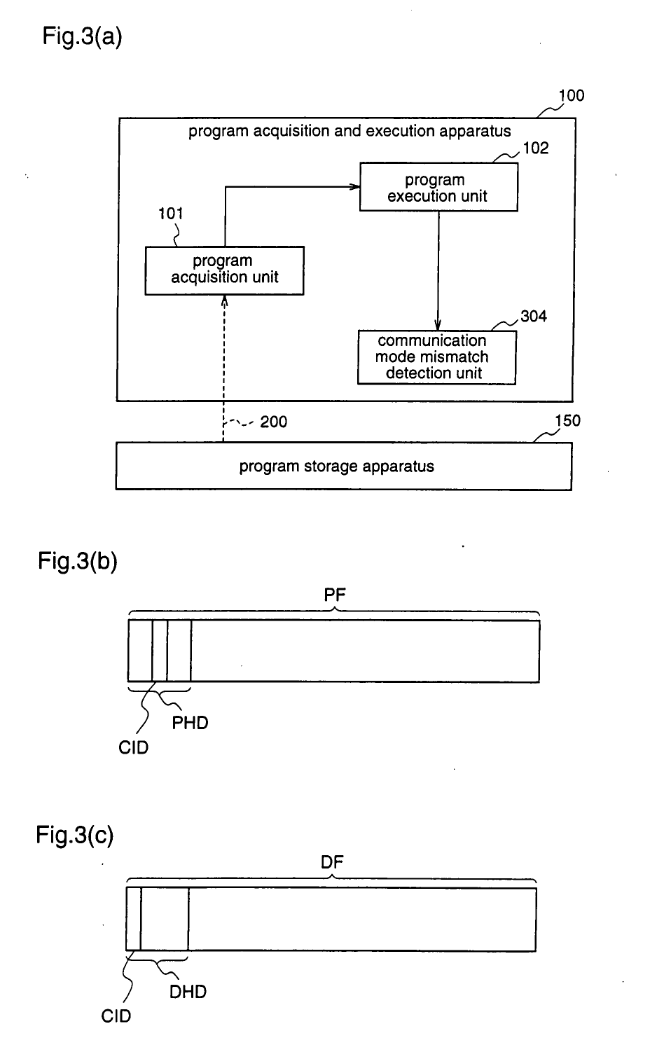

FIG. 3(a) is a block diagram illustrating a program acquisition and execution apparatus according to a second embodiment of the present invention. In FIG. 3(a), the same components as those shown in FIG. 18(a) are denoted by the same reference numerals to omit the description thereof.

In FIG. 3(a), the program acquisition and execution apparatus 100 is provided with a communication mode mismatch detection unit 304 instead of the communication mode conversion unit 203 shown in FIG. 1(a).

The communication mode mismatch detection unit 304 comprises a communication mode mismatch detection program that is recorded in a ROM 1003, a CPU 1001, and a RAM 1002 as a work area.

The communication mode mismatch detection unit 304 detects a mismatch in communication modes when plural programs being executed by the program execution unit 102 communicate with each other.

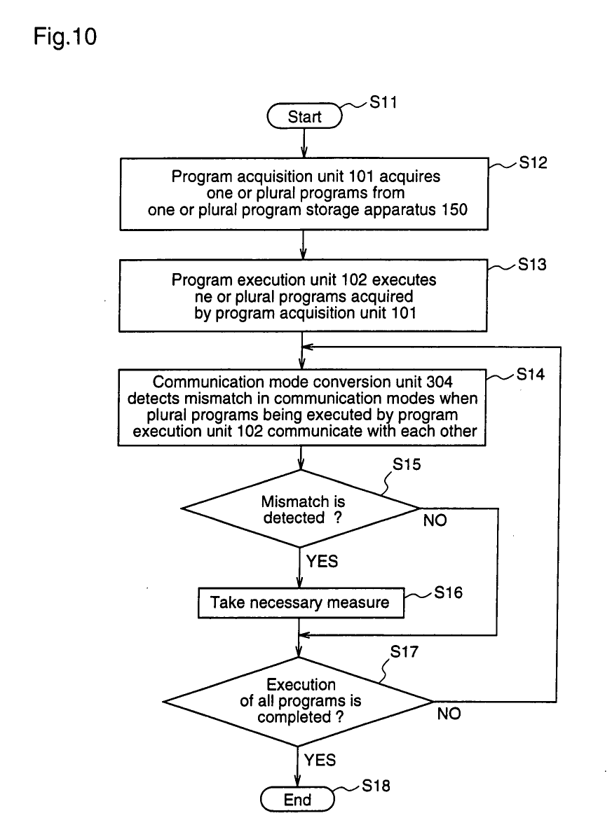

The outline of operation of the program acquisition and execution apparatus 100 will be described with reference to a flowchart shown in FIG. 10. In FIG. 10, steps S11˜S13 are identical to steps S1˜S3 of the flowchart shown in FIG. 7 according to the first embodiment, and therefore, repeated description is not necessary.

After step S13 is ended, the communication mode mismatch detection unit 304 automatically detects a mismatch in communication modes when plural programs being executed by the program execution unit 102 communicate with each other (step S14).

A detection unit for detecting a mismatch in communication modes, which is included in the communication mode mismatch detection unit 304, is implemented as follows. That is, a communication mode identifier CID indicating information that can specify a communication mode, such as a title of communication protocol (e.g., TCP/IP (Transmission Control Protocol/Internet Protocol) or an OSI (Open Systems Interconnection)), is embedded in a specific position (e.g., a portion of a program header PHD or a first byte of a data header DHD) in a program file PF that contains programs to be executed by the program execution unit 102 as shown in FIG. 3(b) or in a data file containing data to be used when the programs communicate with each other as shown in FIG. 3(c), and it is checked as to whether there is a match in the CIDs between the programs performing communication, by the same processing as that described for the flowchart shown in FIG. 1(f). However, the claims of the present invention are not restricted to this communication mode mismatch detection unit.

When a mismatch in communication modes is detected in step S14, a necessary measure such as informing to the user is carried out (step S16). For example, the mobile phone displays, on the display unit, a message informing that a mismatch occurs. When there is no mismatch detected, the processing goes to step S17 (step S15).

When execution of one or plural programs by the program execution unit 102 is completed, the processing is completed (step S18). Otherwise, steps S14˜S17 are repeated (step S17).

As described above, according to the second embodiment, when the program execution unit 102 obtains plural programs and makes the programs operate cooperatively, even if there is a mismatch in communication modes that can be used by the plural programs, since the communication mode mismatch detection unit 304 detects this mismatch, it is possible to take a necessary measure such as notification to the user.

In this second embodiment, the communication mode mismatch detection unit 304 repeatedly performs detection of mismatch in communication modes until all the programs are executed. However, the timing of detecting a mismatch in communication modes by the communication mode mismatch detection unit 304 is not restricted to the above-mentioned example, and the claims of the present invention are not restricted to the communication mode mismatch detection timing of the communication mode mismatch detection unit 304.

### Embodiment 3

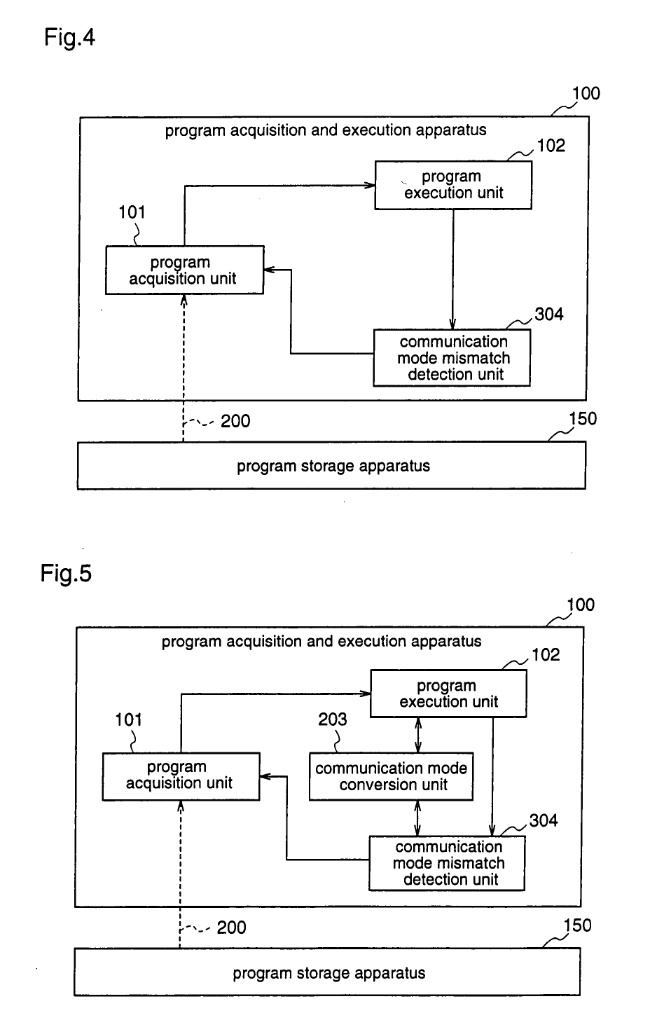

FIG. 4 is a block diagram illustrating a program acquisition and execution apparatus according to a third embodiment of the present invention. In FIG. 4, the same components as those shown in FIGS. 18(a) and 3(a) are denoted by the same reference numerals to omit the description thereof.

In FIG. 4, the program acquisition and execution apparatus 100 have the same components as those shown in FIG. 3(a).

However, in contrast to the construction shown in FIG. 3(a), when the communication mode mismatch detection unit 304 detects a mismatch in communication modes, the program acquisition unit 101 reacquires a program.

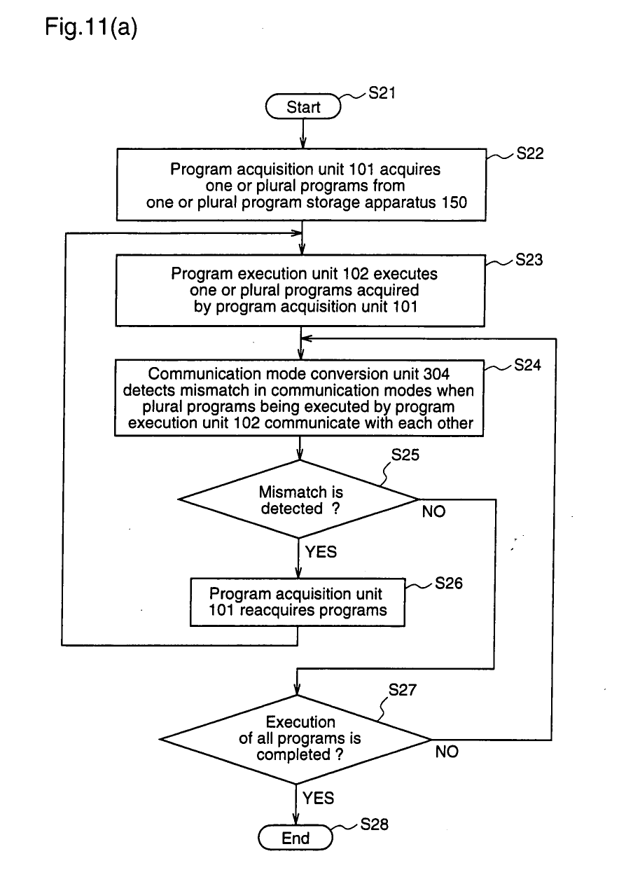

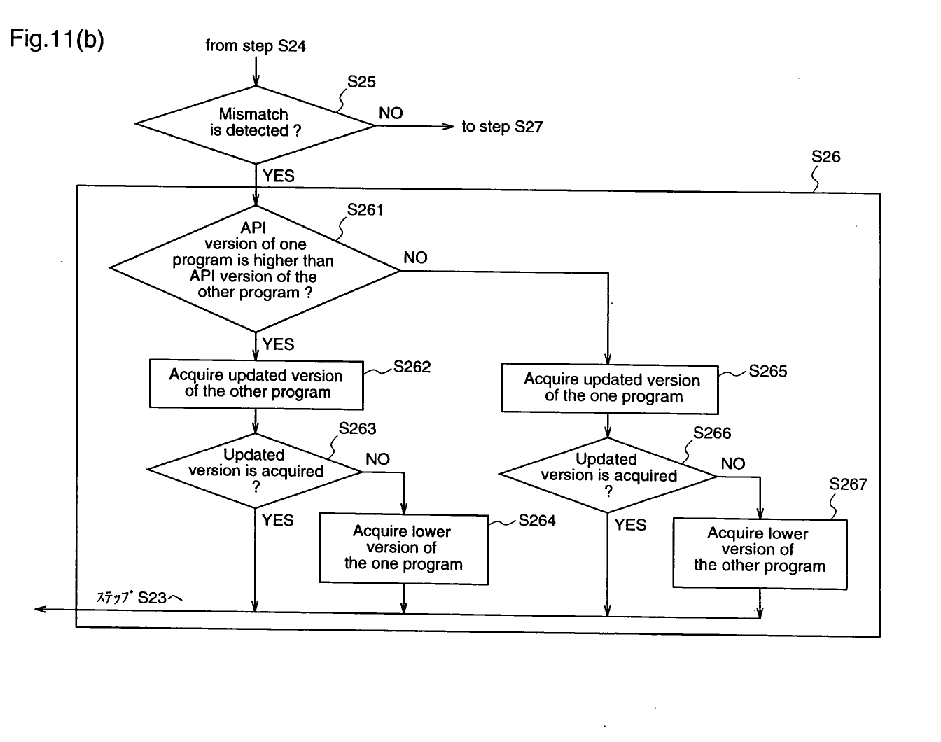

The outline of the operation of the program acquisition and execution apparatus 100 will be described with reference to a flowchart of FIG. 11(a).

With reference to FIG. 11(a), steps S21˜S24 are identical to steps S11˜S14 in the flowchart shown in FIG. 10, and therefore, repeated description is not necessary.

After completion of step S24, when a mismatch in communication modes is detected in step S24 (step S26), the program acquisition unit 101 reacquires a program and restarts the processing from step S23 (the program execution unit 102 restarts the program). Otherwise, the processing goes to step S27 (step S25).

When execution of one or plural programs by the program execution unit 102 is completed, the processing is ended (step S28). Otherwise, steps S24˜S27 are repeated (step S27).

When the mismatch detected in step S25 is a mismatch in APIs, step S26 can be constructed as shown in FIG. 11(b).

That is, when a mismatch is detected, it is checked whether the API version of one program is higher than the API version of the other program (step S261). When the API version of the one program is higher than that of the other program, an updated version of the other program is obtained (step S262).

At this time, it is checked whether the updated version can be obtained or not (step S263), and the processing immediately goes to step S23 when the updated version is obtained. When the updated version cannot be obtained because it is not prepared, a lower version of the one program is obtained so as to match the version of the one program to the version of the other program (step S264), and then the processing goes to step S23.

Further, when the API version of one program is lower than the API version of the other program, operations reverse to those mentioned above are carried out in step S265˜S267. That is, an updated version of the one program is obtained (step S265). At this time, it is checked whether the updated version can be obtained or not (step S266), and the processing immediately goes to step S23 when the updated version is obtained. When the updated version cannot be obtained because it is not prepared, a lower version of the other program is obtained so as to match the version of the other program to the version of the one program (step S267), and the processing goes to step S23.

As described above, according to the third embodiment, in addition to the effects achieved by the program acquisition and execution apparatus according to the second embodiment, since the program acquisition unit 101 reacquires the program in which a mismatch is detected, the program execution unit 102 can execute the plural programs in combinations having no mismatch.

In this third embodiment, when the communication mode mismatch detection unit 304 detects a mismatch in communication modes, the program acquisition unit 101 reacquires the programs, and the program execution unit 102 reexecutes the programs. However, the timing of detecting a mismatch in communication modes by the communication mode mismatch detection unit 304, the timing of reacquiring the programs by the program acquisition unit 101, and the timing of reexecuting the programs by the program execution unit 102 are not restricted to those mentioned above, and therefore, the claims of the present invention are not restricted to the timing of detecting a mismatch in communication modes by the communication mode mismatch detection unit 304, the timing of reacquiring the programs by the program acquisition unit 101, and the timing of reexecuting the programs by the program execution unit 102.

### Embodiment 4

FIG. 5 is a block diagram illustrating a program acquisition and execution apparatus according to a fourth embodiment of the present invention. In FIG. 5, the same components as those shown in FIGS. 18(a), 3(a), and 4 are given the same reference numerals, and descriptions thereof will be omitted.

In FIG. 5, the program acquisition and execution apparatus 100 includes a communication mode conversion unit 203 in addition to the components shown in FIGS. 18(a), 3(a), and 4.

The communication mode conversion unit 203 converts communication modes when plural programs being executed by the program execution unit 102 communicate with each other.

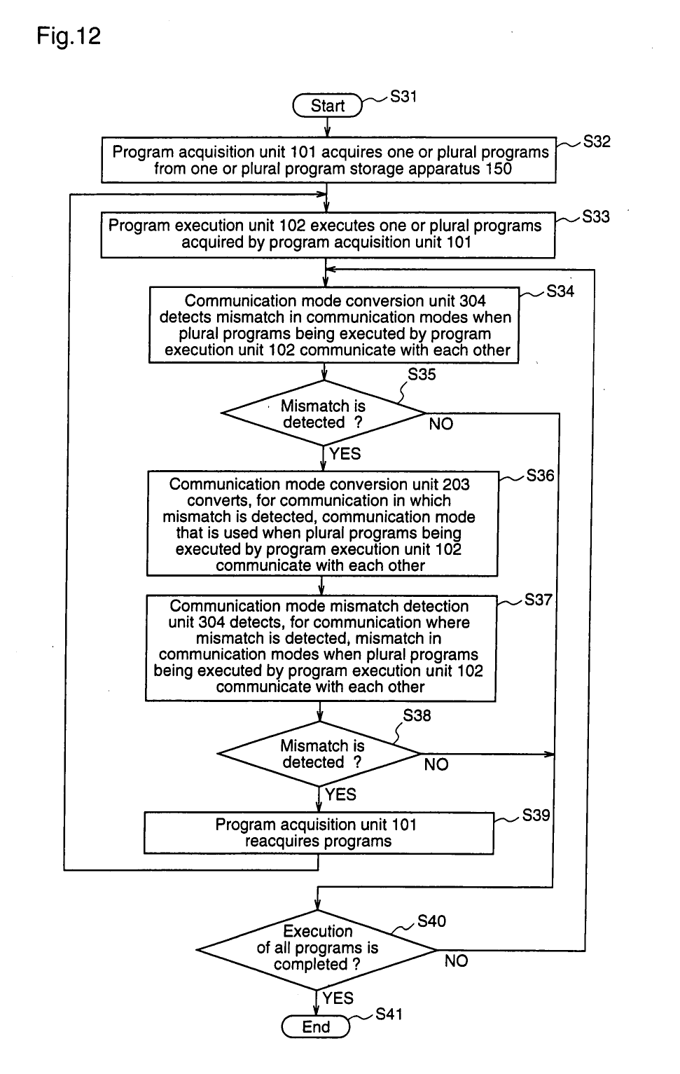

The outline of the operation of the program acquisition and execution apparatus 100 will be described with reference to a flowchart of FIG. 12.

In FIG. 12, steps S31˜S34 are identical to steps S11˜S14 in the flowchart shown in FIG. 10 according to the second embodiment, and therefore, repeated description is not necessary.

When a mismatch in communication modes is detected in step S34, after completion of step S34, the communication mode conversion unit 203 converters, with respect to the communication in which the mismatch is detected, the communication mode at performing mutual communication between the plural programs being executed by the program execution unit 102 (step S36). Otherwise, the processing goes to step S40 (step S35).

The communication mode mismatch detection unit 304 detects a mismatch in communication modes when plural programs being executed by the program execution unit 102 communicate with each other, in like manner as described for step S34 (step S37). Thereby, it is possible to detect the case where a mismatch actually occurs in communication even when the communication mode has been converted and thereby mutual communication should be realized.

After completion of step S37, when a mismatch in communication modes is again detected in step S38, the processing goes to step S39. Otherwise, the processing goes to step S40 (step S38).

When the processing goes to step S39, the program acquisition unit 101 reacquires the programs, and restarts the processing from step S33 (the program execution unit 102 again executes the programs) (step S39).

When the processing goes to step S40, after all the one or plural programs being executed by the program execution unit 102 are completed, the processing is ended (step S41). Otherwise, steps S34˜S40 are repeated (step S40).

Accordingly, in such a case that an initially acquired program is an interim version and thereafter a formal version is released, the interim version program might have a mismatch when it communicates with another program even if the communication mode of the interim version is converted by the communication mode conversion unit 203. In this case, by performing the above-mentioned processing to reacquire the formal-version program, the mismatch in the communication modes with another program can be resolved.

As described above, according to the fourth embodiment of the present invention, in addition to the effects achieved by the program acquisition and execution apparatus according to the second and third embodiments, since the communication mode conversion unit 203 converts the communication modes at performing mutual communication between the plural programs, it is possible to make the plural programs perform communication with each other.

In this fourth embodiment, when the communication mode mismatch detection unit 304 detects a mismatch in communication modes, initially the communication mode conversion unit 203 converts the communication mode for the communication in which the mismatch is detected, and thereafter, the communication mode mismatch detection unit 304 again performs detection of a mismatch in communication modes. When a mismatch in communication modes is again detected, the program acquisition unit 101 reacquires the program, and the program execution unit 102 again executes the program.

However, the timing of detecting a mismatch in communication modes by the communication mode mismatch detection unit 304, the timing of converting the communication mode by the communication mode conversion unit 203, the timing of reacquiring the program by the program acquisition unit 101, and the timing of reexecuting the program by the program execution unit 102 are not restricted to those mentioned above, and therefore, the claims of the present invention are not restricted by the timing of detecting a mismatch in communication modes by the communication mode mismatch detection unit 304, the timing of converting the communication mode by the communication mode conversion unit 203, the timing of reacquiring the program by the program acquisition unit 101, and the timing of reexecuting the program by the program execution unit 102.

### Embodiment 5

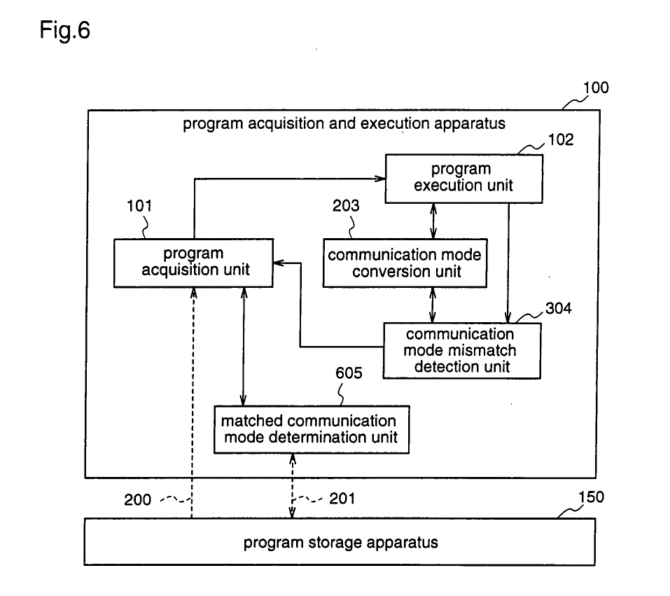

FIG. 6 is a block diagram illustrating a program acquisition and execution apparatus according to a fifth embodiment of the present invention. In FIG. 6, the same constituents as those shown in FIGS. 18(a), 3(a), 4, and 5 are denoted by the same reference numerals to omit the description thereof.

In FIG. 6, the program acquisition and execution apparatus 100 is provided with a matched communication mode determination unit 605 in addition to the constituents shown in FIGS. 18(a), 3(a), 4, and 5.

The matched communication mode determination unit 605 comprises a matched communication mode determination program that is recorded on a ROM 1003, a CPU 1001, and a RAM 1002 as a work area thereof.

The matched communication mode determination unit 605 determines a matched communication mode to be used by a program that is reacquired by the program acquisition unit 101.

The program acquisition unit 101 reacquires a program that uses the communication mode determined by the matched communication mode determination unit 605.

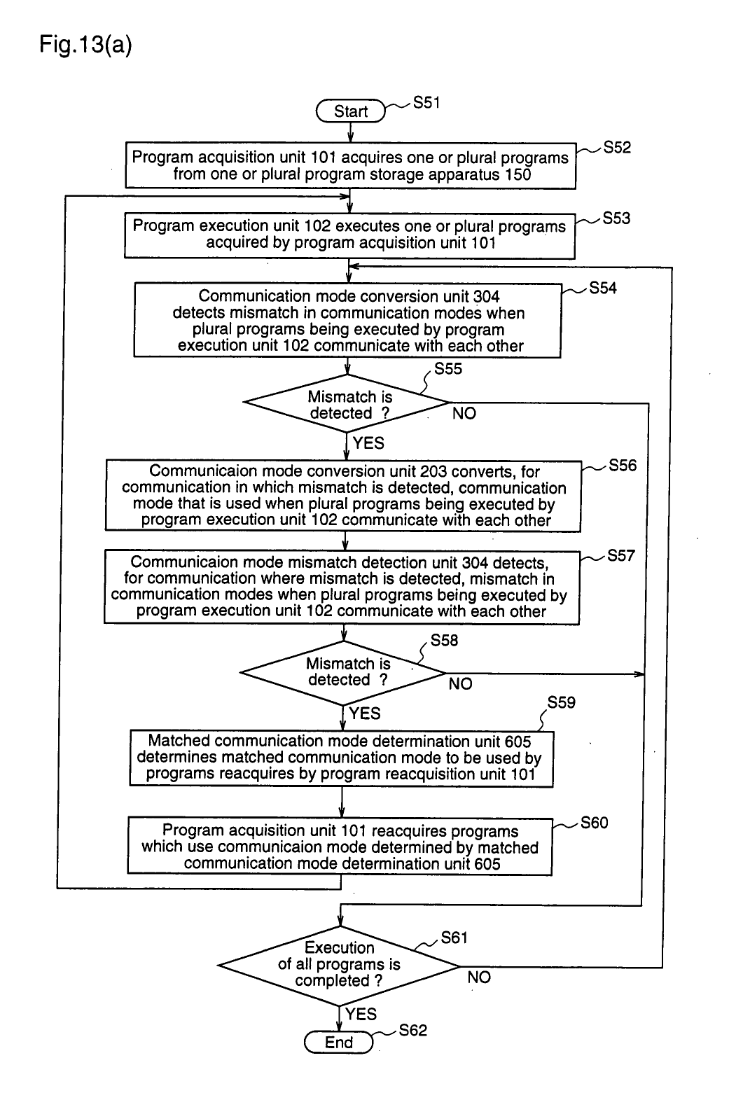

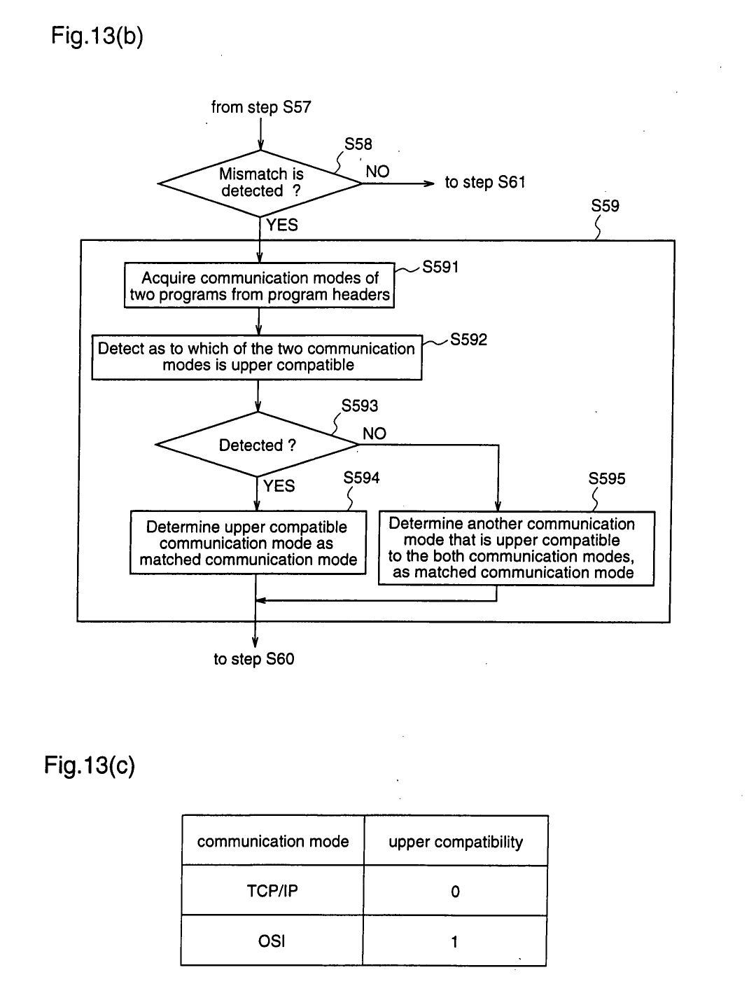

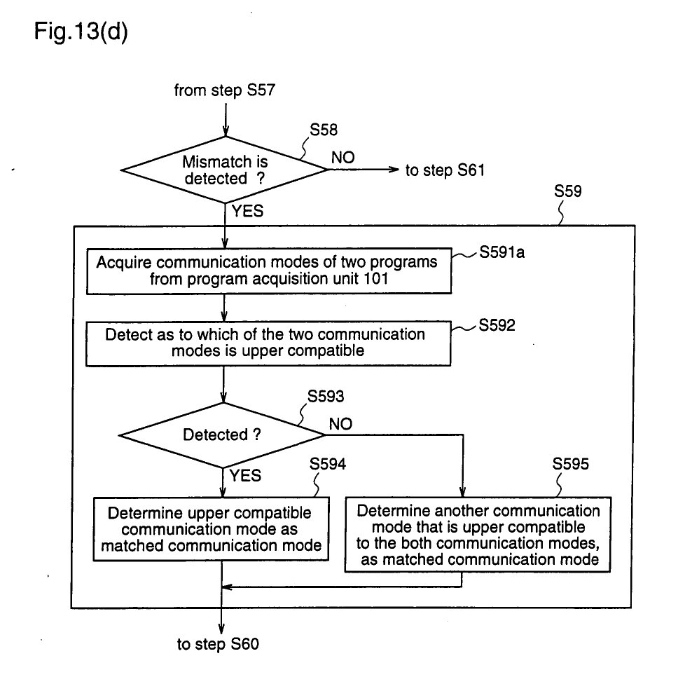

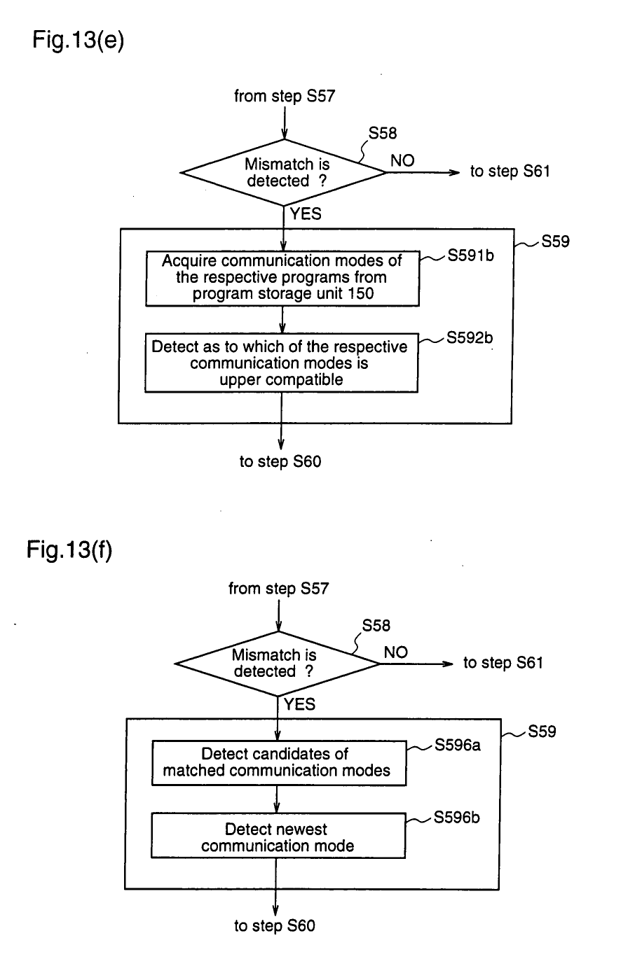

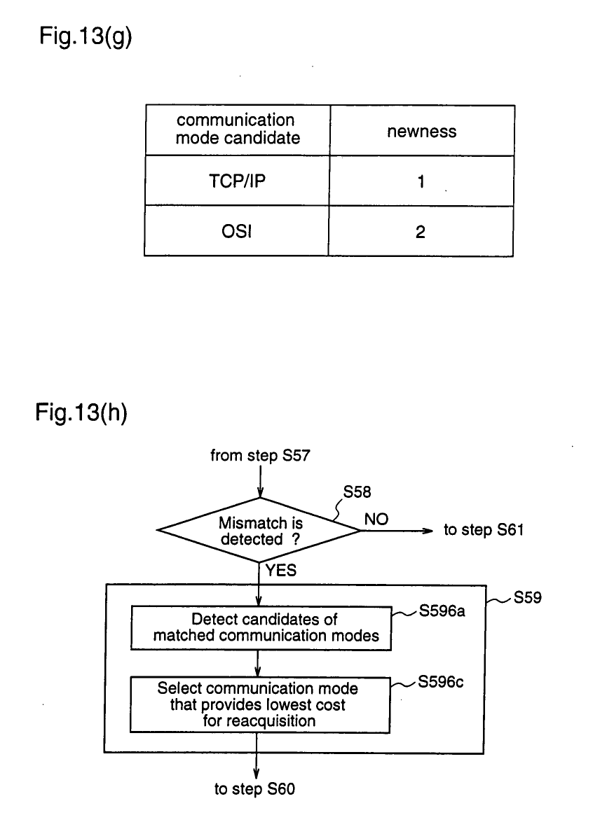

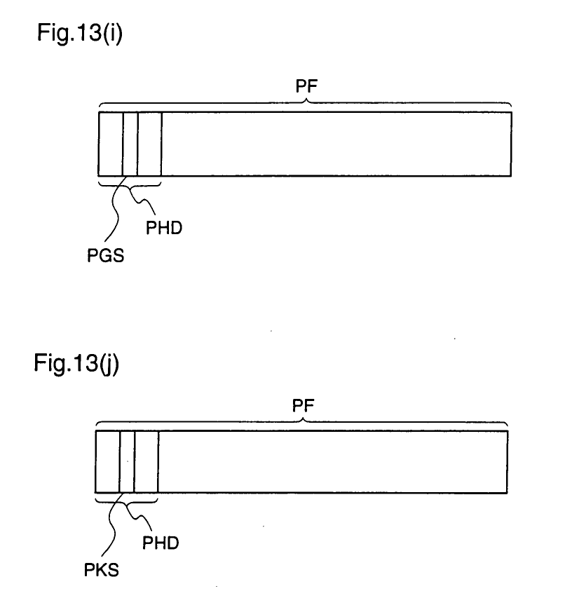

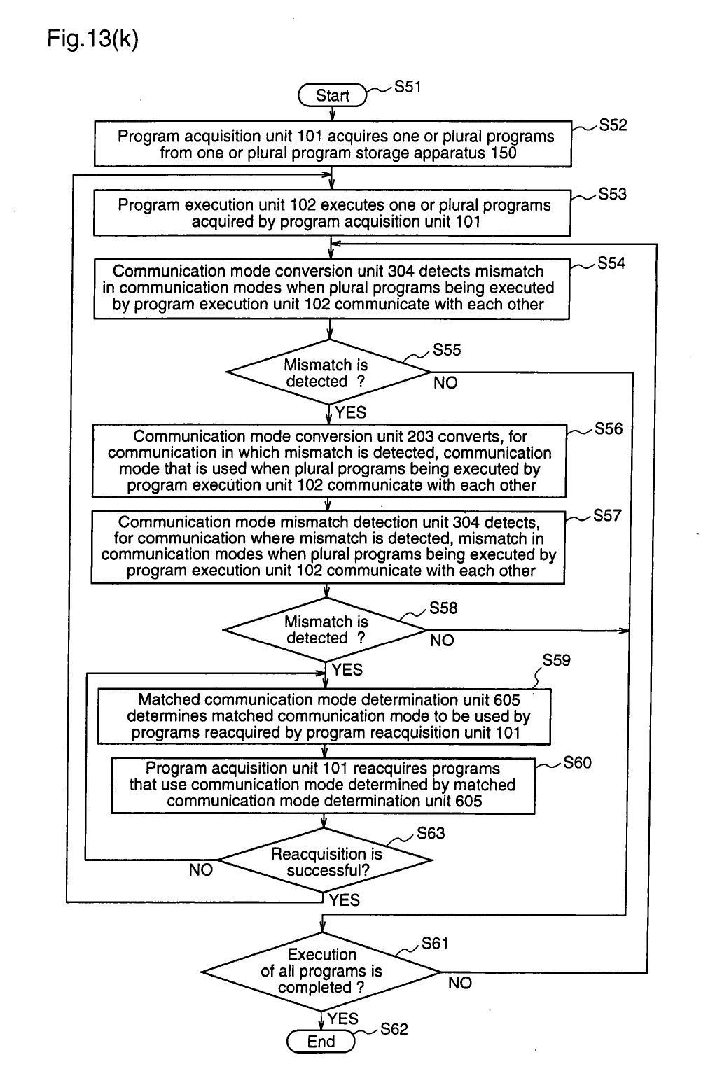

The outline of the operation of the program acquisition and execution apparatus 100 will be described with reference to a flowchart shown in FIG. 13(a). In FIG. 13(a), since steps from S51 to S57 are identical to steps from S31 to S37 of the flowchart shown in FIG. 12 according to the fourth embodiment, repeated description is not necessary.

When a mismatch in communication modes is again detected in step S57, the processing goes to step S59 after completion of step S57. Otherwise, the processing goes to step S61 (step S58).

When the processing goes to step S59, the matched communication mode determination unit 605 determines a matched communication mode to be used by a program that is reacquired by the program acquisition unit 101 (step S59).

For example, as shown in the flowchart of FIG. 13(b), communication modes used by two programs are obtained by extracting communication mode identifiers CID included in headers PHD of program files PF as shown in FIG. 3(b) (step S591), and then it is detected as to which of the communication modes of the two programs is upper compatible (step S592). When the communication mode that is upper compatible can be detected (step S593), the upper compatible communication mode is determined as a matched communication mode (step S594). When the upper compatible communication mode cannot be detected in step S593, a communication mode that is upper compatible with respect to both the two communication modes is determined as a matched communication mode (step S595).

For example, an upper compatible communication mode can be detected by searching a table as shown in FIG. 13(c). In the table, the larger the numerical value of “upper compatibility” is, the upper the compatibility is.

Thereby, if a communication protocol that is used when a mismatch is detected is TCP/IP, OSI that is an upper compatible protocol of the TCP/IP is determined as a matched communication protocol.

The matched communication mode determination unit 605 informs programs using the determined communication mode to the program storage unit 150 through the communication medium 201, and the program acquisition and execution apparatus 100 reacquires the programs transmitted from the program storage unit 150 through the communication medium 200 to again perform the processing from step S53 (i.e., the program execution unit 102 reexecutes the programs) (step S60).

When the processing goes to step S61, when execution of one or plural programs which are executed by the program execution unit 102 is completed, the processing is ended (step S62). Otherwise, steps from S54 to S61 are repeated (step S61).

As described above, according to the construction of the fifth embodiment, in addition to the effects achieved by the program acquisition and execution apparatuses according to the third and fourth embodiments, since a program using a matched communication mode is reacquired for the program in which a mismatch is detected, thereby enabling plural programs being executed by the program execution unit 102 to communicate with each other.

In this fifth embodiment, when the communication mode mismatch detection unit 304 detects a mismatch in communication modes, initially the communication mode conversion unit 203 converts the communication mode for the communication in which the mismatch is detected, and then the communication mode mismatch detection unit 304 again performs detection of a mismatch in communication modes. When a mismatch in communication modes is again detected, the matched communication mode determination unit 605 determines a matched communication mode, and the program acquisition unit 101 reacquires a program, and then the program execution unit 102 reexecutes the program using the determined communication mode.

However, the timing of detecting a mismatch in communication modes by the communication mode mismatch detection unit 304, the timing of converting the communication mode by the communication mode conversion unit 203, the timing of determining a communication mode by the matched communication mode determination unit 605, the timing of reacquiring a program by the program acquisition unit 101, and the timing of reexecuting the program by the program execution unit 102 are not restricted to those mentioned above, and therefore, the claims of the present invention are not restricted by the timing of detecting a mismatch in communication modes by the communication mode mismatch detection unit 304, the timing of converting the communication mode by the communication mode conversion unit 203, the timing of determining a communication mode by the matched communication mode determination unit 605, the timing of reacquiring a program by the program acquisition unit 101, and the timing of reexecuting the program by the program execution unit 102.

### Embodiment 6

The construction of a program acquisition and execution apparatus according to a sixth embodiment of the present invention is identical to that of the program acquisition and execution apparatus according to the fifth embodiment, and it is shown in FIG. 6. However, the function of a constituent thereof, i.e., the matched communication mode determination unit 605, is enhanced from that of the fifth embodiment.

In FIG. 6, as for the constituents having the same functions as those of the fifth embodiment, the description thereof will be omitted.

In FIG. 6, the matched communication mode determination unit 605 determines a matched communication mode from among the communication modes which are used by the programs that have already been acquired by the program acquisition unit 101.

For example, as shown in FIG. 13(d), when two programs are acquired by the program acquisition unit 101, data relating to the communication modes of the programs, such as communication mode identifiers CID, are also acquired and stored, and the matched communication mode determination unit 605 calls up the data from the program acquisition unit 101 to acquire the data (step S591a). Other processes in FIG. 13(d) are identical to those shown in FIG. 13(b).

As described above, according to the construction of the sixth embodiment, in addition to the effects achieved by the program acquisition and execution apparatus according to the fifth embodiment, a matched communication mode is determined from among the communication modes that can be used by the plural programs being executed by the program execution unit 102, and a program that uses the matched communication mode is reacquired, thereby enabling the plural programs to perform communication with each other.

### Embodiment 7

The construction of a program acquisition and execution apparatus according to a seventh embodiment of the present invention is identical to that of the program acquisition and execution apparatus according to the fifth embodiment, and it is shown in FIG. 6. However, the function of a constituent, i.e., the matched communication mode determination unit 605, is enhanced from that of the fifth embodiment.

In FIG. 6, as for the constituents having the same functions as those of the fifth embodiment, the description thereof will be omitted.

In FIG. 6, the matched communication mode determination unit 605 determines a matched communication mode from among the communication modes which are used by the programs that can be reacquired from one or plural program storage apparatus 150.

For example, as shown in FIG. 13(e), the matched communication mode determination unit 605 obtains data relating to the communication modes of the programs that are stored in the program storage unit 150 (step S591b), and detects which of the communication modes of the respective programs is upper compatible, by using a table as shown in FIG. 13(c) (step S592b).

Since a matched communication mode is determined from among the programs which have been prepared as programs that can be replaced by reacquisition, it is possible to avoid that a program which uses the communication mode determined as a matched communication mode does not exist in the program storage unit 150 and thereby the matched communication mode is wasted.

As described above, according to the construction of the seventh embodiment, in addition to the effects achieved by the program acquisition and execution apparatus according to the fifth embodiment, a matched communication mode is determined from among the communication modes which are used by the programs that can be reacquired from the program storage unit 150, and a program that uses the matched communication mode is reacquired, thereby enabling the plural programs being executed by the program execution unit 102 to communicate with each other.

### Embodiment 8

The construction of a program acquisition and execution apparatus according to an eighth embodiment of the present invention is identical to that of the program acquisition and execution apparatus according to any of the fifth to seventh embodiments, and it is shown in FIG. 6. However, the function of a constituent, i.e., the matched communication mode determination unit 605, is enhanced from those of the fifth to seventh embodiments.

In FIG. 6, as for the constituents having the same functions as those of the fifth to seventh embodiments, the description thereof will be omitted.

In FIG. 6, the matched communication mode determination unit 605 selects a latest communication mode from among candidates for matched communication modes, and determines it as a matched communication mode.

For example, as shown in FIG. 13(f), the matched communication mode determination unit 605 detects candidates for matched communication modes (step S596a), and detects the newest communication mode from among the detected candidates by searching a table as shown in FIG. 13(g) (step S596b). In the table, the larger the numerical value of “newness” is, the newer the candidate is.

As described above, according to the construction of the eighth embodiment, in addition to the effects achieved by the program acquisition and execution apparatuses according to the fifth to seventh embodiments, it is possible to make the plural programs executed by the program execution unit 102 perform mutual communication by using as new communication mode as possible.

### Embodiment 9

The construction of a program acquisition and execution apparatus according to a ninth embodiment of the present invention is identical to those of the program acquisition and execution apparatuses according to the fifth to seventh embodiments, and it is shown in FIG. 6. However, the function of a constituent, i.e., the matched communication mode determination unit 605, is enhanced from those of the fifth to seventh embodiments.

In FIG. 6, as for the constituents having the same functions as those described for the fifth to seventh embodiments, the description thereof will be omitted.

In FIG. 6, the matched communication mode determination unit 605 selects a communication mode which minimizes the cost required when the program acquisition unit reacquires a program, from among candidates for matched communication modes, and determines the communication mode as a matched communication mode.

For example, as shown in FIG. 13(h), the matched communication mode determination unit 605 detects candidates for matched communication modes (step S596a), and detects, from the detected candidates, program size data PGS and packet size data PKS in headers PHD of program files PF as shown in FIGS. 13(i) and 13(j), respectively, and then selects a communication mode which minimizes these PGS and PKS (step S596c).

As described above, according to the construction of the ninth embodiment, in addition to the effects achieved by the fifth to seventh embodiments of the present invention, it is possible to minimize the cost required when performing reacquisition for making the plural programs executed by the program execution unit 102 communicate with each other.

### Embodiment 10

The construction of a program acquisition and execution apparatus according to a tenth embodiment of the present invention is identical to those of the program acquisition and execution apparatuses according to the fifth to ninth embodiments, and it is shown in FIG. 6. However, the function of a specific constituent, i.e., the matched communication mode determination unit 605, is enhanced from those of the fifth to ninth embodiments.

In FIG. 6, as for the constituents having the same functions as those described for the fifth to ninth embodiments, the description thereof will be omitted.

In FIG. 6, when the program acquisition unit 101 fails in acquisition of a program that uses the matched communication mode determined by the matched communication mode determination unit 605, the matched communication mode determination unit 605 again determines a matched communication mode, and then the program acquisition unit 101 reacquires a program that uses the communication mode redetermined by the matched communication mode determination unit 605.

As shown in FIG. 13(k), there is provided a step S63 for detecting as to whether the program reacquisition in step S60 is successful or not, and it is detected in step S63 as to whether the program reacquisition is successful or not. When the program acquisition unit 101 fails in the reacquisition, the processing returns to step S59 to redetermine a matched communication mode.

Notification of this failure in reacquisition is performed as follows. For example, the program storage unit 150 detects its database according to a request from the program acquisition unit 101, and when the program storage unit 150 cannot detect the corresponding program, it sets a flag indicating that effect.

As described above, according to the construction of the tenth embodiment, in addition to the effects achieved by the program acquisition and execution apparatuses according to the fifth to ninth embodiments, even when the program acquisition unit 101 fails in reacquisition of a program which uses a communication mode determined as a matched communication mode, since a matched communication mode is redetermined and then a program that uses the redetermined matched communication mode is reacquired, it is possible to make the plural programs being executed by the program execution unit 102 communicate with each other.

### Embodiment 11

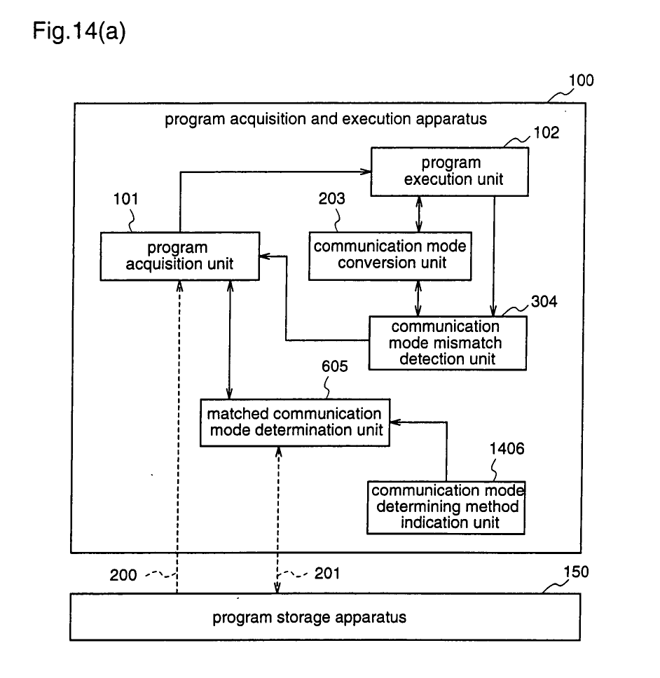

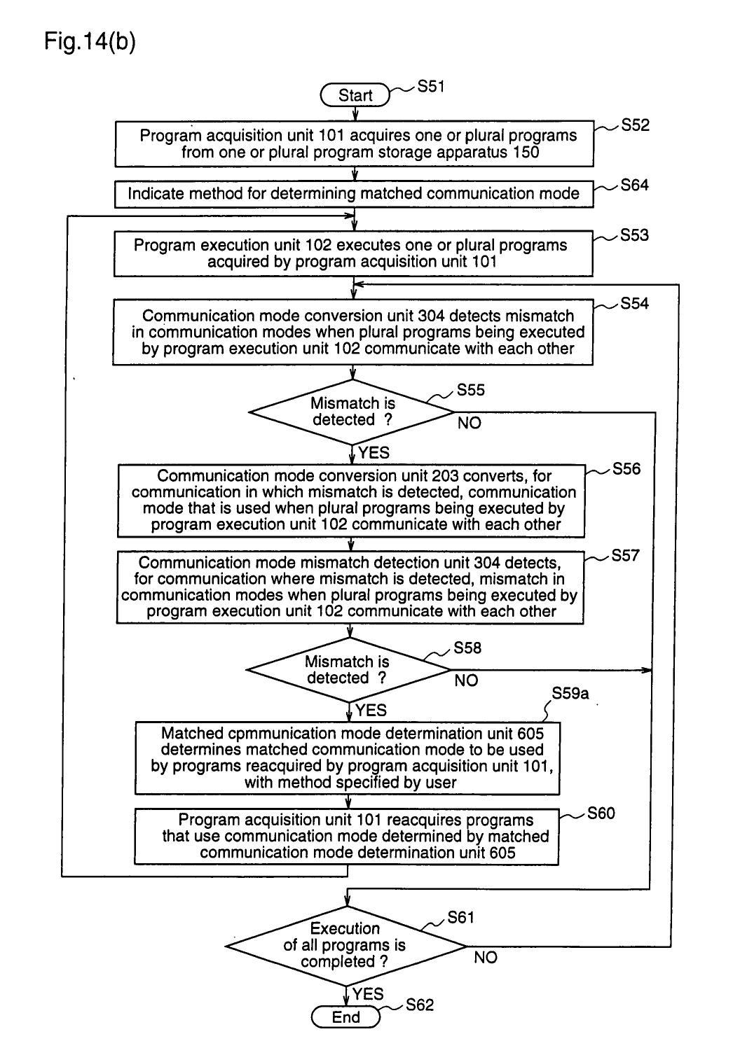

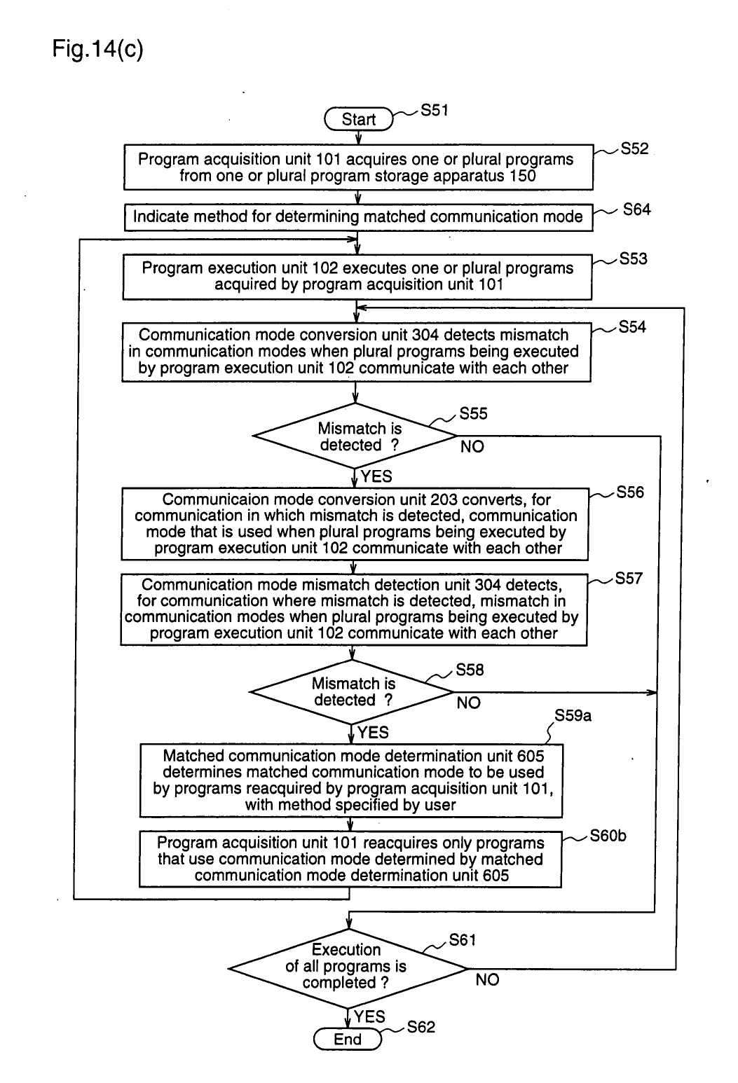

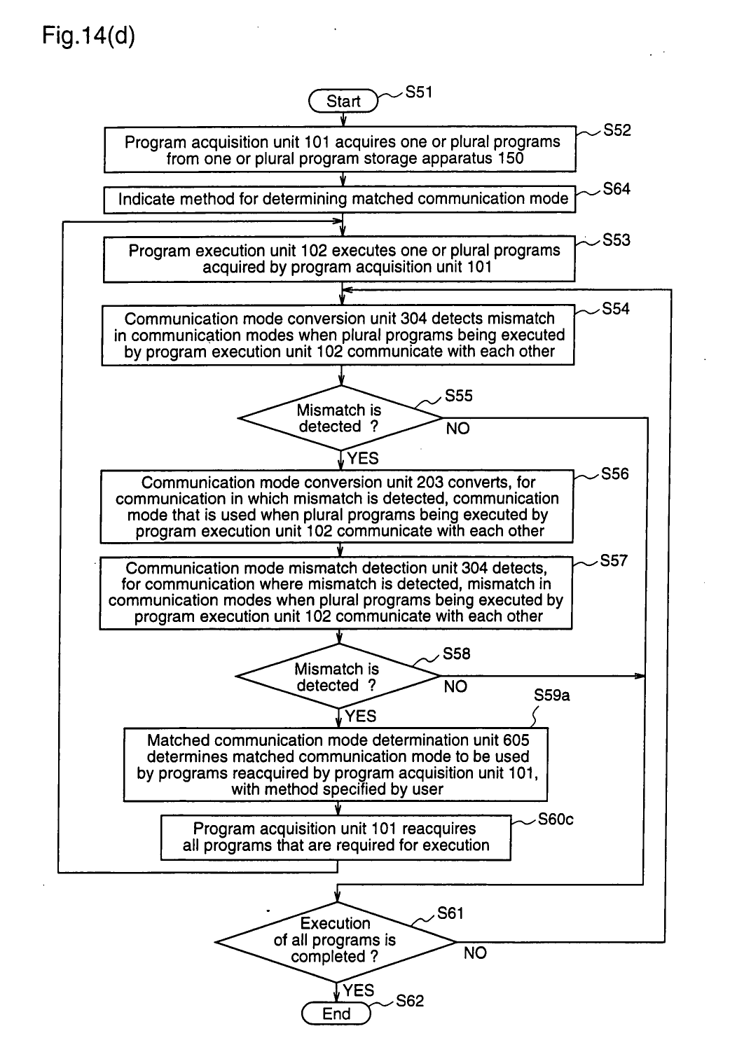

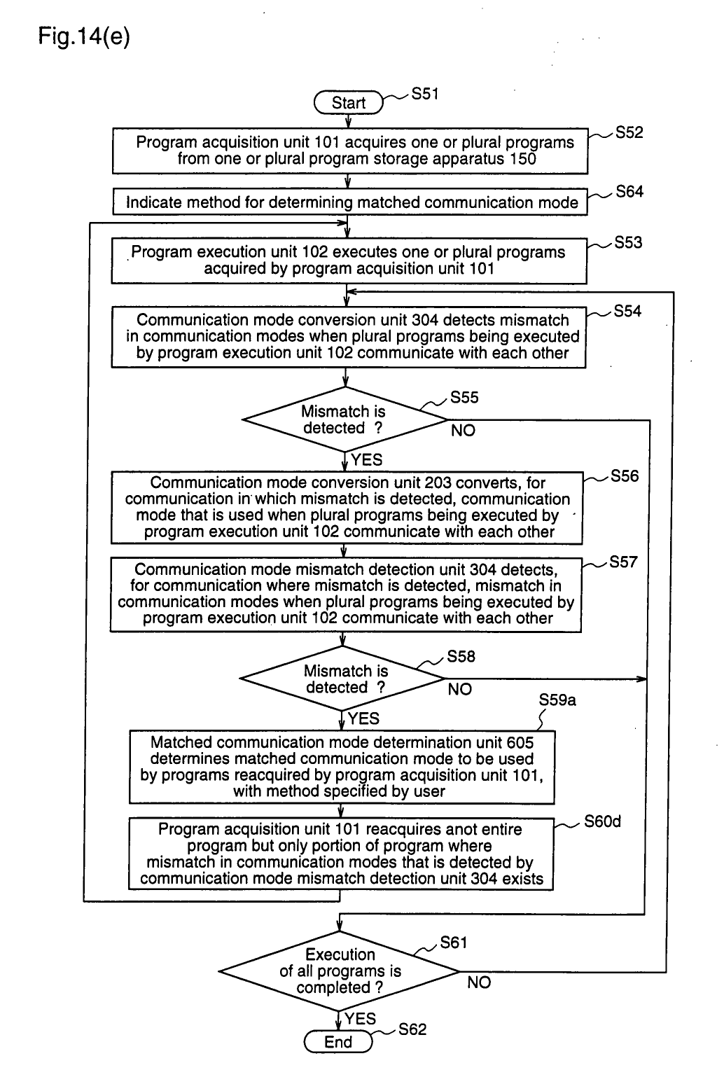

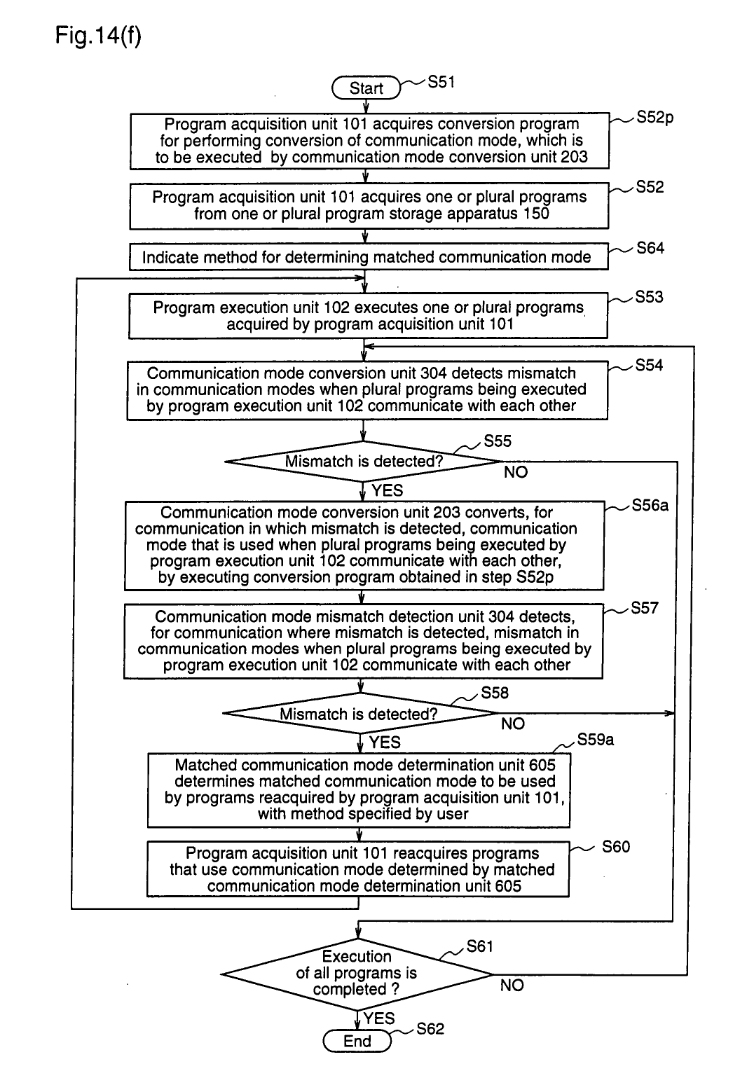

FIG. 14(a) is a block diagram illustrating a program acquisition and execution apparatus according to an eleventh embodiment of the present invention. In FIG. 14(a), the same constituents as those shown in FIG. 18(a) and FIGS. 3 to 6 are denoted by the same reference numerals to omit the description thereof.

In FIG. 14(a), the program acquisition and execution apparatus 100 is provided with a communication mode determining method indication unit 1406 in addition to the constituents shown in FIG. 18(a) and FIGS. 3 to 6.

Using the communication mode determining method indication unit 1406, the user specifies a method by which the communication mode determination unit 605 determines a matched communication mode.

The matched communication mode determination unit 605 determines a matched communication mode by the method specified by the communication mode determining method indication unit 1406.

As shown in FIG. 14(b), the user previously indicates a method for determining a matched communication mode by using a keyboard, a cursor key, or the like (step S64), and when a mismatch in communication modes is detected (step S58), the matched communication mode determination unit 605 determines a communication mode that is used by a program to be reacquired by the program reacquisition unit 101, according to the indicated method (step S59a).

For example, the method for determining a matched communication mode, which is specified by the user, may determine a communication mode according to any of the methods described for the eighth to tenth embodiments, or another desired rule.

As described above, according to the construction of the eleventh embodiment, in addition to the effects achieved by the program acquisition and execution apparatuses according to the fifth to tenth embodiments, the user can select a method for determining a matched communication mode, and a program which uses a matched communication mode that is determined by the method selected by the user is reacquired, thereby enabling the plural programs executed by the program execution unit 102 to communicate with each other.

### Embodiment 12

The construction of a program acquisition and execution apparatus according to a twelfth embodiment of the present invention is identical to that of the program acquisition and execution apparatus according to the eleventh embodiment, and it is shown in FIG. 14(a). However, the function of a specific constituent thereof is extended from those of the fifth to eleventh embodiments. In FIG. 14(a), as for the constituents having the same functions as those described for the fifth to eleventh embodiments, the description thereof will be omitted.

In FIG. 14(a), the program acquisition unit 101 reacquires only a program in which the communication mode mismatch detection unit 304 detects a mismatch in communication modes.

As shown in FIG. 14(c), the user previously specifies a method for determining a matched communication mode (step S64), and the matched communication mode determination unit 605 determines a matched communication mode according to the indication by the user (step S59a) and, thereafter, the program acquisition unit 101 reacquires only a program for which the communication mode mismatch detection unit 304 detects a mismatch, which program uses the communication mode determined by the matched communication mode determination unit 605 (step S60b).

As described above, according to the construction of the twelfth embodiment, in addition to the effects achieved by the program acquisition and execution apparatuses according to the fifth to eleventh embodiments, since the program acquisition unit 101 reacquires not all of the plural programs executed by the program execution unit 102 but only a program in which a mismatch is detected, efficient reacquisition of program is realized.

### Embodiment 13

The construction of a program acquisition and execution apparatus according to a thirteenth embodiment of the present invention is identical to those of the program acquisition and execution apparatuses according to the eleventh and twelfth embodiments, and it is shown in FIG. 14(a). However, the function of a specific constituent thereof is extended from those of the fifth to eleventh embodiments. In FIG. 14(a), as for the constituents having the same functions as those described for the fifth to eleventh embodiments, the description thereof will be omitted.

In FIG. 14(a), the program acquisition unit 101 reacquires all the programs required for execution.

As shown in FIG. 14(d), the user previously specifies a method for determining a matched communication mode (step S64), and the matched communication mode determination unit 605 determines a matched communication mode according to the method specified by the user (step S59a), and then the program acquisition unit 101 reacquires all the programs which use the communication mode determined by the matched communication mode determination unit 605 and are required by the program execution unit 102 to perform program execution (step S60c).

As described above, according to the construction of the thirteenth embodiment, in addition to the effects achieved by the program acquisition and execution apparatuses according to the fifth to eleventh embodiments, since the program acquisition unit 101 reacquires all the plural programs executed by the program execution unit 102, it is possible to avoid an occurrence of further mismatch which is caused by that only part of the plural programs is acquired.

### Embodiment 14

The construction of a program acquisition and execution apparatus according to a fourteenth embodiment of the present invention is identical to those of the program acquisition and execution apparatuses according to the eleventh to thirteenth embodiments, and it is shown in FIG. 14(a). However, the function of a specific constituent, i.e., the program acquisition unit 101, is extended from those of the fifth to thirteenth embodiments. In FIG. 14(a), as for the constituents having the same functions as those described for the fifth to thirteenth embodiments, the description thereof will be omitted.

In FIG. 14(a), the program acquisition unit 101 reacquires not the entire program but only a portion of the program where a mismatch in communication modes which is detected by the communication mode mismatch detection unit 304 exists.

More specifically, as shown in FIG. 14(e), the user previously specifies a method for determining a matched communication mode (step S64), and the matched communication mode determination unit 605 determines a matched communication mode according to the method specified by the user (step S59a), and then the program acquisition unit 101 reacquires only a portion of a program that uses the communication mode determined by the matched communication mode determination unit 605, wherein a mismatch in communication modes which is detected by the communication mode mismatch detection unit 304 exists (step S60d).

The acquisition of only a portion where a communication mode mismatch exists is realized by, for example, previously forming programs in module units, and reacquiring only a module relating to communication by referring to information in a module header.

As described above, according to the construction of the fourteenth embodiment, in addition to the effects achieved by the program acquisition and execution apparatuses according to the fifth to thirteenth embodiments, since only a portion of a program wherein a communication mode mismatch exists is reacquired, the cost required for reacquisition can be further minimized.

### Embodiment 15

The construction of a program acquisition and execution apparatus according to a fifteenth embodiment of the present invention is identical to those of the program acquisition and execution apparatuses according to the eleventh to fourteenth embodiments, and it is shown in FIG. 14(a). However, the function of a specific constituent, i.e., the communication mode conversion unit 203, is extended from those of the first embodiment or the fourth to fourteenth embodiments. In FIG. 14(a), as for the constituents having the same functions as those described for the first embodiment or the fourth to fourteenth embodiments, the description thereof will be omitted.

In FIG. 14(a), the communication mode conversion unit 203 converts the communication mode by executing a conversion program for converting the communication mode, and the program acquisition unit 101 acquires the conversion program executed by the communication mode conversion unit 203.

To be specific, as shown in FIG. 14(f), the program acquisition unit 101 previously acquires a conversion program for converting the communication mode, which program is to be executed by the communication mode conversion unit 203 (step S52p), and the user previously specifies a method for determining a matched communication mode (step S64), and then the communication mode conversion unit 203 executes the conversion program obtained in step S52p to convert the communication mode (step S56a).

As described above, according to the construction of the fifteenth embodiment, in addition to the effects achieved by the program acquisition and execution apparatuses according to the first embodiment or the fourth to fourteenth embodiments, since the communication mode at performing mutual communication between the plural programs being executed by the program execution unit 102 is converted according to the conversion program obtained from the program storage unit 150, it is possible to change the conversion method itself for converting the communication mode when the plural programs communicate with each other.

### Embodiment 16

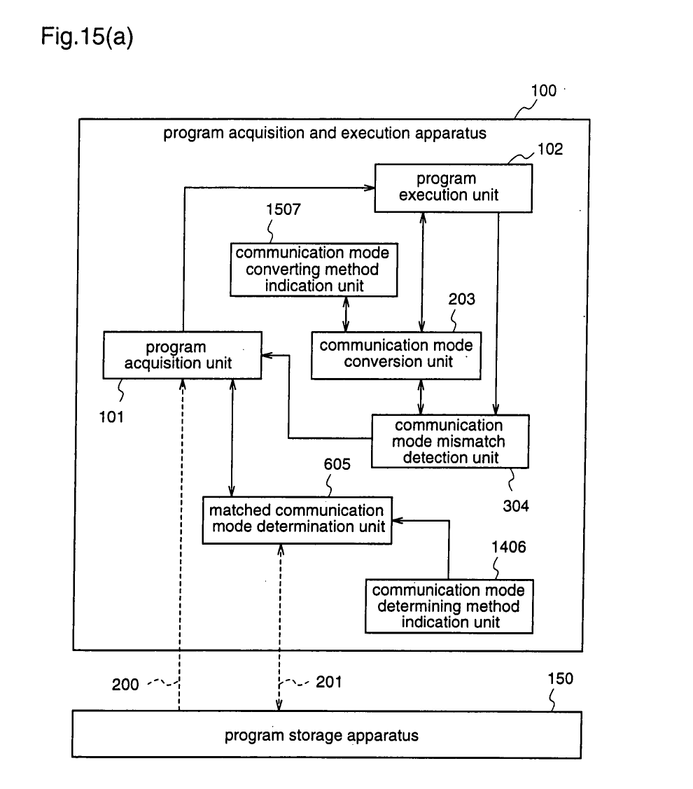

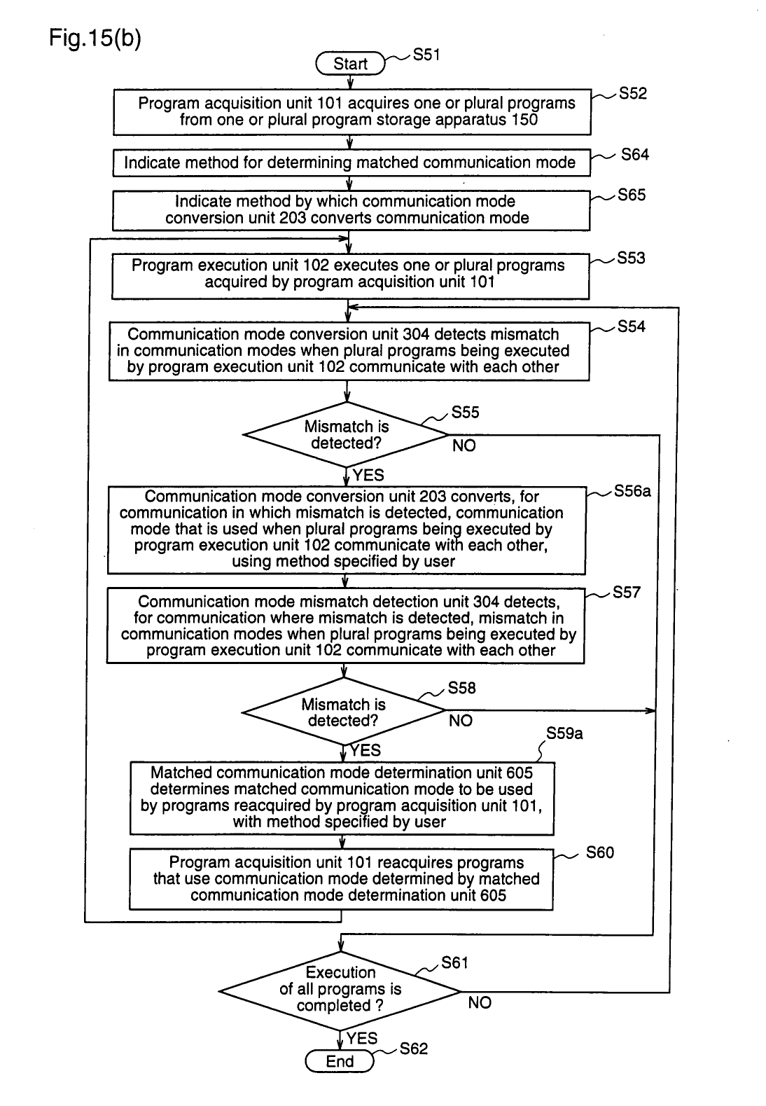

FIG. 15(a) is a block diagram illustrating a program acquisition and execution apparatus according to a sixteenth embodiment of the present invention. In FIG. 15(a), the same constituents as those shown in FIGS. 18(a), 3˜6, and 14(a) are denoted by the same reference numerals to omit the description thereof.

In FIG. 15(a), the program acquisition and execution apparatus 100 is provided with a communication mode conversion method indication unit 1507 in addition to the constituents shown in FIGS. 18(a), 3 to 6, and 14(a). The communication mode conversion method indication unit 1507 specifies a method by which the communication mode conversion unit 203 converts the communication mode. The communication mode conversion unit 203 converts the communication mode according to the method specified by the communication mode conversion method indication unit 1507.

To be specific, as shown in FIG. 15(b), the user previously specifies a communication mode conversion method to be used by the communication mode conversion unit 203 (step S65), and the communication mode conversion unit 203 converts the communication mode at performing mutual communication between the plural programs being executed by the program execution unit 102, with respect to the communication in which a mismatch is detected, according to the method specified by the user.

As described above, according to the construction of the sixteenth embodiment, in addition to the effects achieved by the program acquisition and execution apparatuses according to the first embodiment or the fourth to fifteenth embodiments, the user can select a method for converting the communication mode, and the communication mode conversion unit 203 converts the communication mode at performing mutual communication between the plural programs being executed by the program execution unit 102, according to the method selected by the user, thereby enabling the plural programs to communicate with each other.

### Embodiment 17

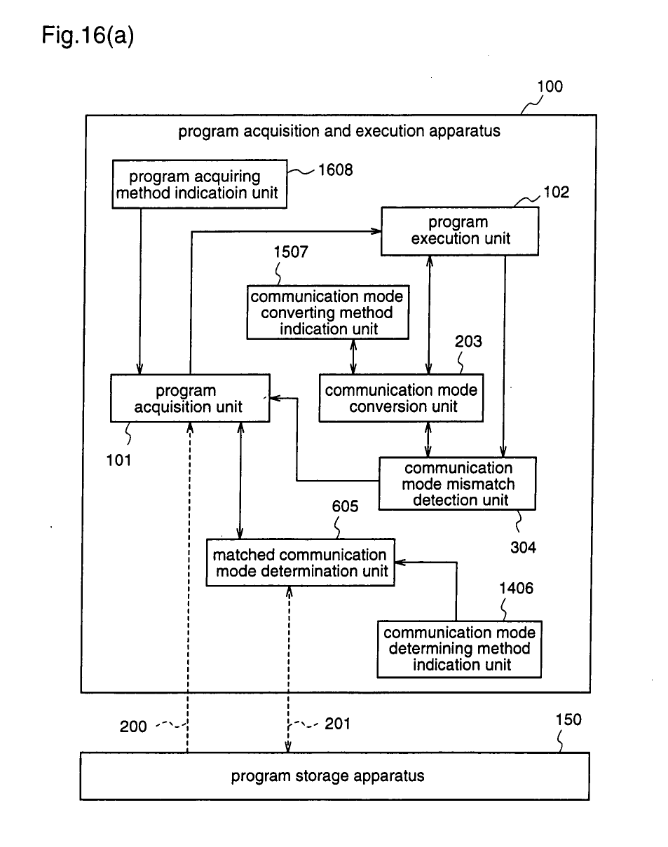

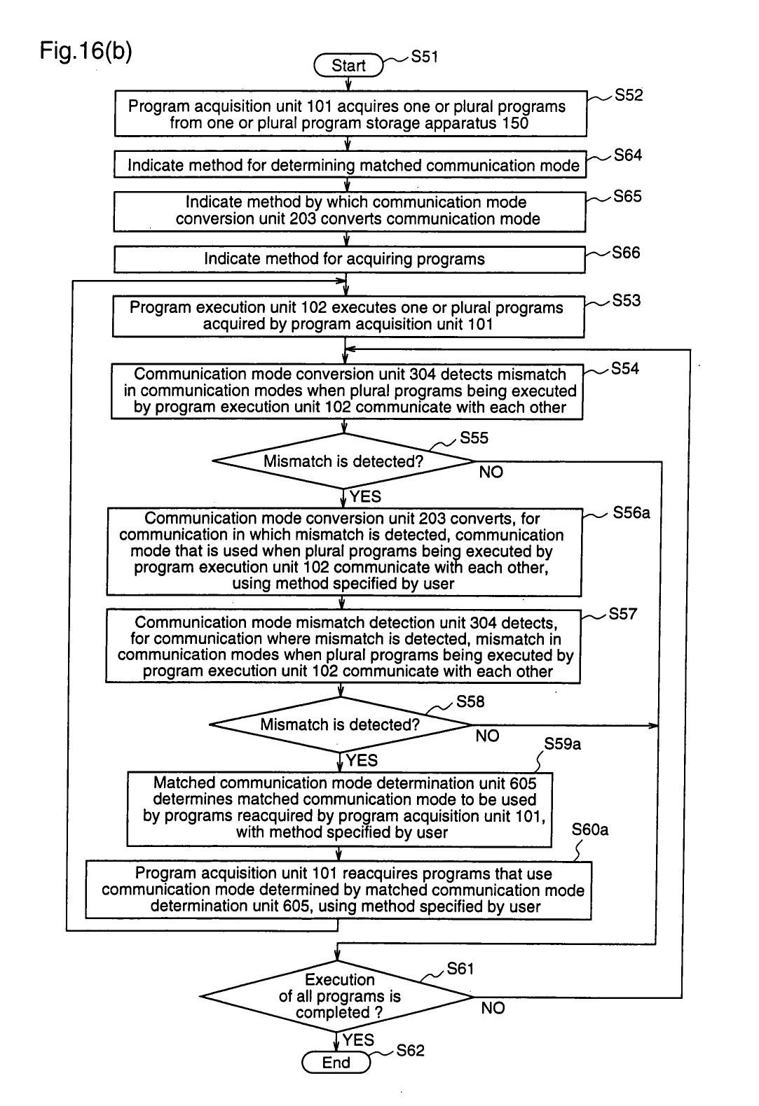

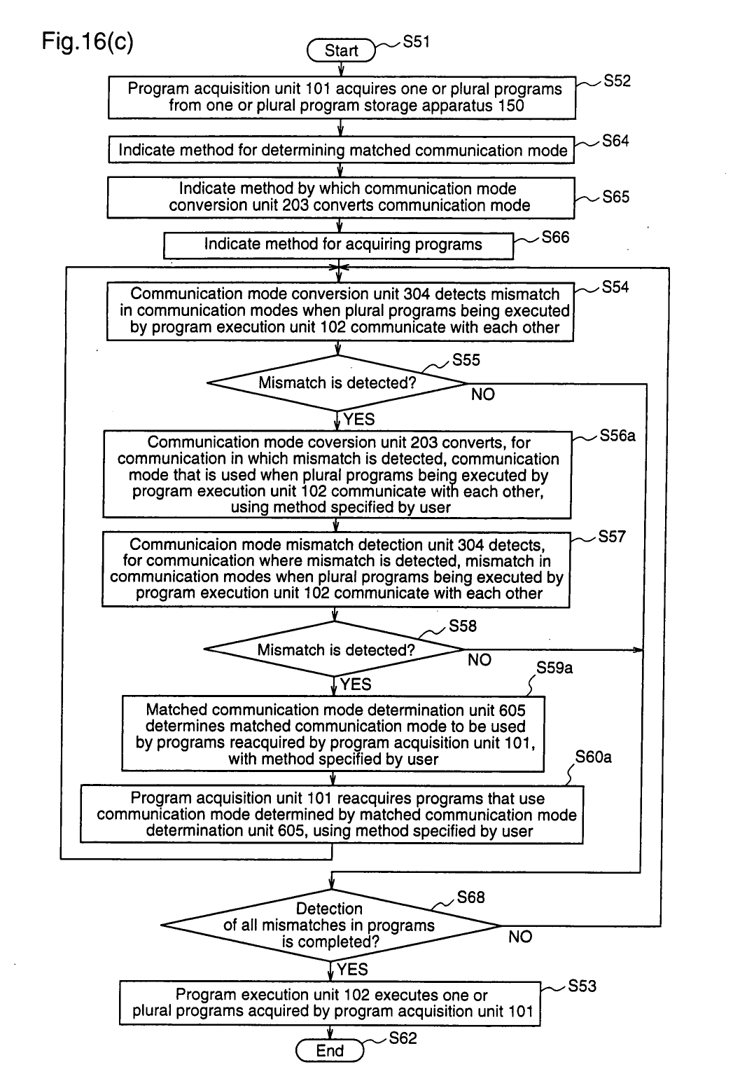

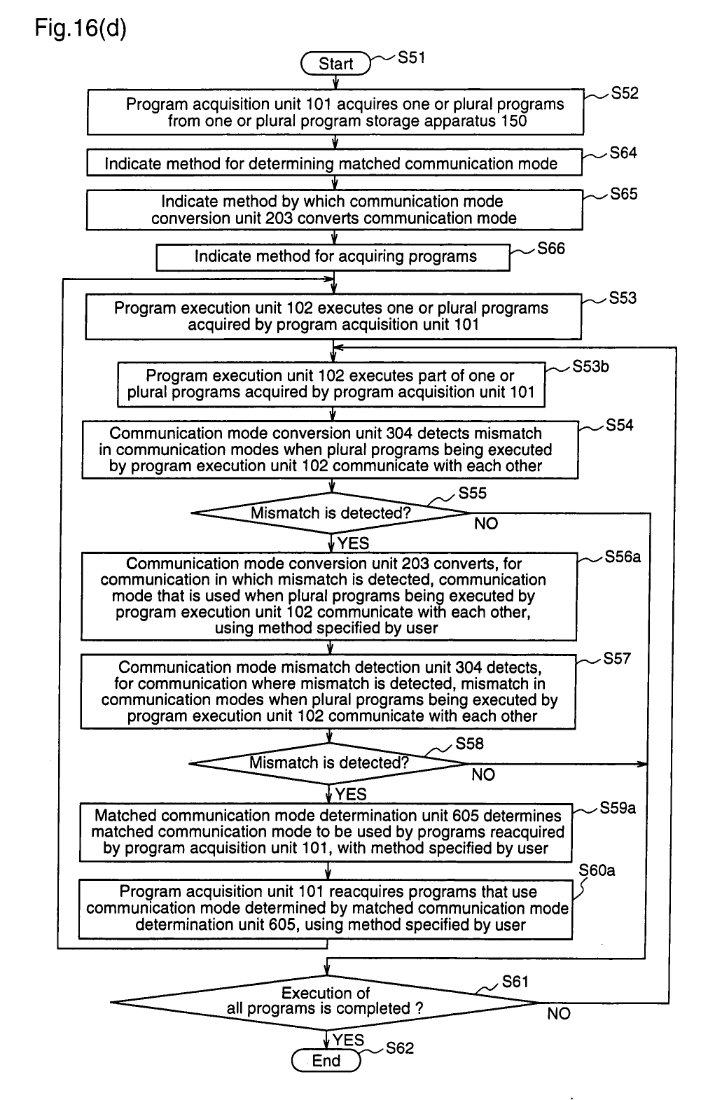

FIG. 16(a) is a block diagram illustrating a program acquisition and execution apparatus according to a seventeenth embodiment of the present invention. In FIG. 16(a), the same constituents as those shown in FIGS. 18(a), 3-6, 14(a), and 15(a) are denoted by the same reference numerals to omit the description thereof.

In FIG. 16(a), the program acquisition and execution apparatus 100 is provided with a program acquisition method indication unit 1608 in addition to the constituents shown in FIGS. 18(a), 3 to 6, 14(a), and 15(a).

The program acquisition method indication unit 1608 indicates a method by which the program acquisition unit 101 acquires a program.

The program acquisition unit 101 acquires a program according to the method indicated by the program acquisition method indication unit 1608.

To be specific, as shown in FIG. 16(b), the user previously specifies a method for acquiring a program (step S66), and the program acquisition unit 101 reacquires a program that uses the communication mode determined by the matched communication mode determination unit 605, according to the method specified by the user (step S60a).

As described above, according to the construction of the seventeenth embodiment, in addition to the effects achieved by the program acquisition and execution apparatuses according to the first embodiment or the fourth to sixteenth embodiments, the user can select a method for acquiring a program, and the program acquisition unit 101 reacquires a program in which a mismatch is detected, according to the method selected by the user, thereby enabling the plural programs executed by the program execution unit 102 to communicate with each other.

### Embodiment 18

The construction of a program acquisition and execution apparatus according to an eighteenth embodiment of the present invention is identical to the construction of the program acquisition and execution apparatus according to the seventeenth embodiment, and it is shown in FIG. 16(a). However, the function of a specific constituent thereof is enhanced from those of the second to seventeenth embodiments. In FIG. 16(a), as for the constituents having the same functions as those described for the second to seventeenth embodiments, the description thereof will be omitted.

In FIG. 16(a), the communication mode mismatch detection unit 304 detects a mismatch in communication modes before the program execution unit 102 starts execution of program.

To be specific, as shown in FIG. 16(c), the user previously specifies a method for designating a matched communication mode (step S64), and the communication mode mismatch detection unit 304 detects all mismatches (steps S55, S58, S68) in the communication modes at performing mutual communication between the plural programs, in steps S54 to S60a before program execution by the program execution unit 102 (step S53). This detection of mismatches before the program execution is realized by, for example, previously referring to the communication mode identifiers CID in the program files PF as shown in FIGS. 3(b) and 3(c).

As described above, according to the construction of the eighteenth embodiment, in addition to the effects achieved by the program acquisition and execution apparatuses according to the second to seventeenth embodiments, since mismatches in communication modes are detected before execution of program is started and then execution of program is started after all of the detected mismatches are resolved, it is possible to avoid reacquisition or reexecution of a program during execution of the program.

### Embodiment 19

The construction of a program acquisition and execution apparatus according to a nineteenth embodiment of the present invention is identical to the constructions of the program acquisition and execution apparatuses according to the seventeenth and eighteenth embodiments, and it is shown in FIG. 16(a). However, the function of a specific constituent thereof is enhanced from those of the second to seventeenth embodiments. In FIG. 16(a), as for the constituents having the same functions as those described for the second to seventeenth embodiments, the description thereof will be omitted. In FIG. 16(a), the communication mode mismatch detection unit 304 successively detects mismatches in communication modes while the program execution unit 102 is executing programs.

To be specific, as shown in FIG. 16(d), the user previously specifies a method for designating a matched communication mode (step S64), and the communication mode mismatch detection unit 304 successively detects a mismatch in communication modes at performing mutual communication between the plural programs being executed by the program execution unit 102 (step S53b), every time a program is executed in steps S54 to S60a. This detection of mismatches during program execution can be realized by, for example, referring to the communication mode identifiers CID in the program files PF during program execution as shown in FIGS. 3(b) and 3(c).

As described above, according to the construction of the nineteenth embodiment, in addition to the effects achieved by the program acquisition and execution apparatuses according to the second to seventeenth embodiments, a mismatch in communication modes is successively detected every time a program is executed line by line or portion by portion during execution of the program, and the detected mismatch is successively resolved, thereby avoiding a delay in execution start due to detection of mismatches before program execution.

### Embodiment 20

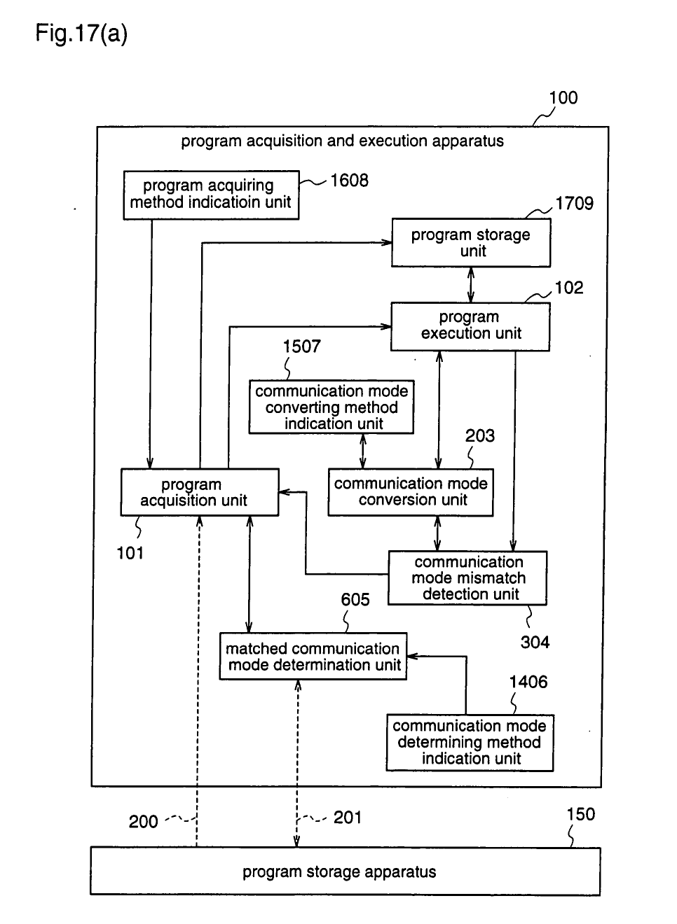

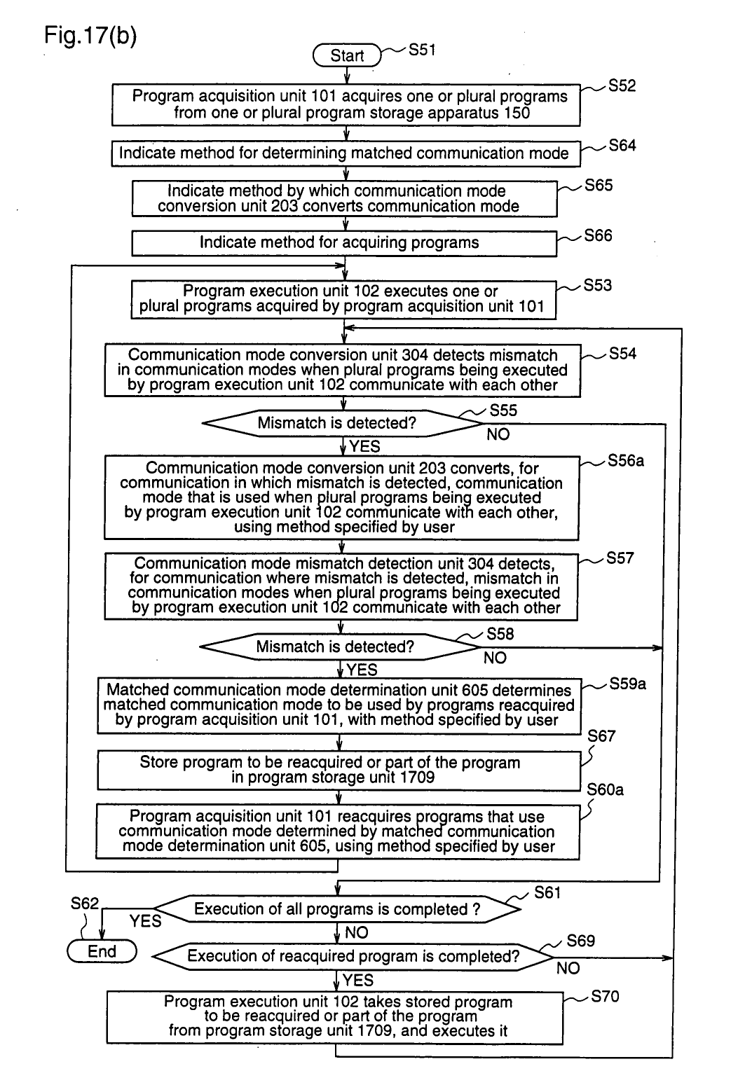

FIG. 17(a) is a block diagram illustrating a program acquisition and execution apparatus according to a twentieth embodiment of the present invention. In FIG. 17(a), the same constituents as those shown in FIGS. 18(a), 3˜6, and 14(a)˜16(a) are denoted by the same reference numerals to omit the description thereof.

In FIG. 17(a), the program acquisition and execution apparatus 100 is provided with a program storage unit 1709 in addition to the constituents shown in FIGS. 18(a), 3˜6, and 14(a)˜16(a).

The program storage unit 1709 stores a program that is a target program to be reacquired by the program acquisition unit 101, or a portion of the program.

The program execution unit 102 executes the program that is reacquired by the program reacquisition unit 101 or a portion of the program, and thereafter, executes a program stored in the program storage unit 1709.

This processing is realized by the flowchart shown in FIG. 17(b). That is, before the program acquisition unit 101 reacquires a program which uses a communication mode that is determined by the matched communication mode determination unit 605, according to a method specified by the user, the program acquisition unit 101 previously stores the program to be reacquired or a portion of the program in the program storage unit 1709 (step S67). Then, the program acquisition unit 101 reacquires the program (step S60a), thereby resolving the mismatch in step S55 or S58. Thereafter, the program execution unit 102 takes and executes the program as a target of reacquisition or a portion of the program, which program is stored in the program storage unit 1709 (step S69, S70).

As described above, according to the construction of the twentieth embodiment, in addition to the effects achieved by the program acquisition and execution apparatuses according to the third to nineteenth embodiments of the invention, a program using a matched communication mode is reacquired and executed while the corresponding original program in which a mismatch is detected is stored, that is, the mismatch is resolved by reacquiring the program and the temporarily replaced program is returned to the original program after a portion where a mismatch occurs in the original program is executed safely, whereby the original program can be executed after the mismatch in the communication modes is resolved.

While in this twentieth embodiment reacquisition of program is performed to resolve a mismatch portion, resolving of mismatch may be performed by conversion of the program.

Further, while in the respective embodiments mentioned above an embedded computer having only a RAM as a rewritable storage device is described, the present invention is also applicable to computers having various kinds of rewritable file devices such as a magnetic disk drive, an optical disc drive, and a magnet-optical disk drive as a rewritable storage device.

Further, while in the respective embodiments the program acquisition and execution apparatus includes only a ROM as a nonvolatile memory device, it may includes a non-rewritable file device such as a CD-ROM or a DVD-ROM.

When such rewritable file device or non-rewritable file device is used, a monitor program such as an OS, an interpreter such as a Java™ virtual machine, a middleware, and an application program, which have been stored in the ROM, may be stored in the file unit.

Further, while updation of programs of a mobile phone is described as a variation of the present invention, the present invention is also applicable to updation of programs of the above-mentioned embedded computer, domestic network-enabled devices including HAVi, Internet-connectable domestic devices, devices connectable to wired or wireless communication networks including mobile phones, devices connectable to broadcast networks including television receivers and radio receivers, and personal computers.

Further, as for updation of programs of a mobile phone, while plural makers that manufacture mobile phones of the same telecommunication carrier cooperatively operate a system for updation, the respective makers may operate their own systems for updation. In this case, it is not necessary to include information of the maker name in the updation wish list. Further, while a mobile phone having such as Internet-connectable i Mode™ is described, the system for updation may be operated using communication media other than the Internet, such as distribution of programs through public telecommunication network itself. Furthermore, while both the communication medium 200 and the communication medium 201 are used, a single communication medium may be shared by time-division or the like.

Furthermore, while the mobile phone is provided with the communication mode conversion unit 203, it may be provided with a communication mode mismatch detection unit 304 or a matched communication mode determination unit 605. In this case, the communication mode mismatch detection unit 304 or the matched communication mode determination unit 605 may comprise programs stored in a ROM 1115, a control unit 1109, and a RAM 1114 as a work area.

While in the respective embodiments the program acquisition and execution apparatuses are described, the present invention may be implemented as a program acquisition and execution method. In this case, the program acquisition unit, the program execution unit, the communication mode conversion unit, the communication mode mismatch detection unit, and the matched communication mode determination unit may be implemented as processes corresponding to the functions of the respective units, i.e., a program acquisition process, a program execution process, a communication mode conversion process, a communication mode mismatch detection process, and a matched communication mode determination process.

Furthermore, the program acquisition and execution method including these processes may be implemented as a program acquisition and execution program, and this program acquisition and execution program may be recorded on a storage medium to implement a program acquisition and execution program storage medium.

Furthermore, while TCP/IP and OSI are adopted as examples of communication protocols, available communication protocols are not restricted thereto.

### APPLICABILITY IN INDUSTRY

A program acquisition and execution apparatus according to the present invention is characterized by that, when plural programs are acquired (downloaded or uploaded) from a program storage device through a communication medium such as a network or a radio communication device to execute the programs, even if there is a mismatch in communication modes between the plural programs, another program can be utilized, and therefore, the program acquisition and execution apparatus has a very wide range of applications, as a method for resolving version mismatch and protocol mismatch between downloadable or uploadable programs. Although there is no particular restriction on applications, the program acquisition and execution apparatus is applicable to updation of software embedded in home electric appliances through networks or radio communication devices and to downloading of applications to Internet browsers.

1. A program acquisition and execution apparatus for acquiring programs from a program storage apparatus through a communication medium, and executing the programs, said apparatus comprising:
a program acquisition unit for acquiring programs from the program storage apparatus;
a program execution unit for executing the programs that are acquired by the program acquisition unit; and
a communication mode conversion unit for converting communication modes at performing mutual communication between the plural programs being executed by the program execution unit.

2. A program acquisition and execution apparatus for acquiring programs from a program storage apparatus through a communication medium, and executing the programs, said apparatus comprising:
a program acquisition unit for acquiring programs from the program storage apparatus;
a program execution unit for executing the programs that are acquired by the program acquisition unit; and
a communication mode mismatch detection unit for detecting a mismatch in communication modes when the plural programs being executed by the program execution unit communicate with each other.

3. A program acquisition and execution apparatus as defined in claim 2 wherein, when the communication mode mismatch detection unit detects a mismatch in communication modes, the program acquisition unit reacquires a program.

4. A program acquisition and execution apparatus as defined in claim 2 further including a communication mode conversion unit for converting a communication mode at performing mutual communication between plural programs being executed by the program execution unit, when the communication mode mismatch detection unit detects a mismatch in communication modes.

5. A program acquisition and execution apparatus as defined in claim 3 further including:
a matched communication mode determination unit for determining a matched communication mode to be used by the program reacquired by the program acquisition unit; and
said program acquisition unit reacquiring a program which uses the communication mode that is determined by the matched communication mode determination unit.

6. (canceled)

7. (canceled)

8. (canceled)

9. (canceled)

10. A program acquisition and execution apparatus as defined in claim 5 wherein, when the program acquisition unit fails in acquisition of a program which uses the matched communication mode that is determined by the matched communication mode determination unit, the matched communication mode determination unit redetermines a matched communication mode, and the program acquisition unit reacquires a program which uses the communication mode that is redetermined by the matched communication mode determination unit.

11. A program acquisition and execution apparatus as defined in claim 5 further including:
a communication mode determining method indication unit for indicating a method by which the communication mode determination unit determines a matched communication mode; and
said communication mode determination unit determining a matched communication mode by the method that is indicated by the communication mode determining method indication unit.

12. (canceled)

13. (canceled)

14. (canceled)

15. A program acquisition and execution apparatus as defined in claim 1 wherein said communication mode conversion unit converts a communication mode by executing a conversion program for performing conversion of a communication mode, and said program acquisition unit acquires the conversion program to be executed by the communication mode conversion unit.

16. (canceled)

17. (canceled)

18. (canceled)

19. (canceled)

20. (canceled)

21. A program acquisition and execution method for acquiring programs from a program storage apparatus through a communication medium, and executing the programs, said method comprising:
a program acquisition step of acquiring programs from the program storage apparatus;
a program execution step of executing the programs that are acquired in the program acquisition step; and
a communication mode conversion step of converting communication modes at performing mutual communication between plural programs being executed by the program execution step.

22. A program acquisition and execution method as defined in claim 21, including, instead of the communication mode conversion step, a communication mode mismatch detection step of detecting a mismatch in communication modes when plural programs being executed by the program execution unit communicate with each other.

23. (canceled)

24. (canceled)

25. (canceled)

26. (canceled)
